(19) United States
(12) Patent Application Publication
(10) Pub. No.: US 2021/0352438 A1
(43) Pub. Date: Nov. 11, 2021

(54) LOCATION-SPECIFIC NOTIFICATION SYSTEM

(71) Applicant: Texas Emergency Network, LLC, Austin, TX (US)

(72) Inventors: Curtis E. Ford, Austin, TX (US); Katheryn Huynh, Austin, TX (US); Annie Atkinson, Manor, TX (US); Maggie Welch, Austin, TX (US)

(21) Appl. No.: 16/870,283

(22) Filed: May 8, 2020

(51) Int. Cl. H04W 4/029; H04W 4/021; H04W 4/02; H04W 4/12; H04W 4/90; H04L 29/08; G06F 16/29

(52) U.S. Cl. CPC H04W 4/029; H04W 4/021; H04W 4/023; G06F 16/29; H04W 4/90; H04L 67/18; H04W 4/12

(57) ABSTRACT

Techniques are disclosed relating to disseminating location-specific emergency messages to various user devices or digital signs. In some embodiments, a computer system, such as an emergency management system, may obtain location-specific resource data that indicates a status of one or more resources in a geographic area. The computer system may provide a map-centric interface that is operable to display the status of the one or more resources in the geographic area. For example, in some embodiments, the map-centric interface includes a graphical map that depicts icons for the one or more resources at respective locations on the graphical map. The computer system may then receive, via the map-centric interface, a selection of a particular geographic area for which to send a location-specific message. Based on this selection, the computer system may identify and send a location-specific message to one or more mobile devices currently located in that particular geographic area.

### CROSS REFERENCE TO RELATED APPLICATIONS

This application is related to U.S. application Ser. No. 16/395,438, filed Apr. 26, 2019, which is a continuation of U.S. application Ser. No. 15/876,670, filed Jan. 22, 2018 (now U.S. Pat. No. 10,275,111), which is a continuation of U.S. application Ser. No. 15/583,986, filed May 1, 2017 (now U.S. Pat. No. 9,874,993), which is a continuation of U.S. application Ser. No. 14/980,773, filed Dec. 28, 2015 (now U.S. Pat. No. 9,639,233), which is a continuation of U.S. application Ser. No. 13/896,915, filed May 17, 2013 (now U.S. Pat. No. 9,221,385), which claims priority to U.S. Provisional Appl. No. 61/649,120, filed May 18, 2012; all of which are hereby incorporated by reference in their entireties.

### BACKGROUND

### Technical Field

This disclosure relates generally to emergency notification systems, and more particularly to disseminating location-specific emergency messages to various user devices and digital signs.

### Description of the Related Art

The emergency broadcast system (“EBS”) was in existence from the early 1960s until 1997. The EBS, although intended as a national alert system, was predominantly used by state and local governments to disseminate emergency information to persons who may be affected. Generally only a nationwide activation of the EBS was required to be relayed by broadcast stations (the FCC made local emergencies and weather advisories optional). Broadcast stations generally included radio and television stations; however, many stations were classified as non-participating. The EBS was replaced in 1997 by the emergency alert system (“EAS”) which has the same primary purpose of disseminating emergency information through broadcast television and radio stations. The EAS has very limited capabilities providing only for the transmission of text and audio—no images can be transmitted. Although all broadcast stations and multichannel video programming distributors are required to maintain equipment to decode and encode the EAS signals, some are excepted out of the requirement as non-participating stations by the FCC.

The EAS and EBS systems have several inherent problems. The notifications were relatively limited in information and had no capability for providing more than text and audio. This severely hampers the effectiveness of the notification. The notifications had to be dispatched to a relatively large area such as an entire metropolitan statistical area (“MSA”) which, according to the 2000 census, averages over 600k residents each. This further limited the current emergency notification systems because the system was only employed for notifications that affected some significant portion of the MSA. The notifications only reached those residents actively watching a traditional broadcast station in real time or listening to a local radio station. With the advent of mobile devices (such as smartphones, tablet computers, etc.) and streaming media, fewer people are listening to local radio stations or watching broadcast television. Even if people generally did listen to local radio stations or watch broadcast television, there is a relatively small chance any particular person would be listening when the notification was actually delivered.

These limitations highlight the inability of current systems to effectively: target a specific area affected by an emergency; convey relevant and detailed information regarding the emergency and any suggested responses; and convey the message to individuals who are in the general vicinity of the emergency.

According to the Outdoor Advertising Association of America, billboards and similar signage are the oldest mass advertising medium. There are an estimated 400,000 billboards in the United States. Traditional billboards have a static image and are positioned in relatively high traffic areas to increase the chances that more individuals will pass the signs and thereby view the advertisement. Early in the industry's history, the signs were painted directly onto the billboard. This was later replaced by printed paper pasted on the billboard, and more recently, to computer-generated images on plastic substrates. The most recent evolution has been to digital billboards.

Digital billboards (officially named “changeable electronic variable message signs” or “CEVMS”) mark a huge advancement in outdoor advertising and signage because they enable a changeable message/image, drastically reduce the cost of changing the message/image (in some cases even enabling the remote changing of the message/image), and permit multiple messages/images to be cycled at preset intervals (e.g. seven or eight seconds).

In view of the above shortcomings of existing emergency notification systems, there is a need for an improved emergency notification system that utilizes the ubiquity of mobile devices and digital signs and that can be used by governmental entities to disseminate all types of emergency, threat, and warning information in an effective and efficient manner.

### BRIEF DESCRIPTIONS OF THE DRAWINGS

FIG. 1 depicts a graphical overview of one general system architecture that could be employed to implement the disclosed subject matter, according to some embodiments.

FIGS. 2a, 2b, 2c, and 2d depict various flow charts of the process and information flow of an embodiment of the disclosed subject matter.

FIG. 3 depicts a graphical overview of a general system architecture that could be employed to implement the disclosed subject matter with the addition of third party digital sign control systems, according to some embodiments.

FIGS. 4a and 4b depict exemplary graphical maps that could be transmitted to the user to show the approximate location of cameras or digital signs in relation to structures, landmarks, roads, or the like, according to some embodiments.

FIGS. 5a through 5k depict exemplary emergency messages, according to some embodiments.

FIG. 6 depicts a graphical overview of a general system architecture that could be employed to implement the disclosed subject matter with the addition of a travel database, according to some embodiments.

FIG. 7 depicts various aspects of interface components according to an embodiment of this disclosure.

FIGS. 8A-8B depict block diagrams illustrating a system for distributing location-specific notifications, according to some embodiments.

FIGS. 9A-9B depict block diagrams of example map-centric interfaces that may be used to disseminate location-specific emergency notifications to various users or digital signs, according to some embodiments.

FIGS. 10A-10B depict block diagrams of an example user device and emergency notification application, according to some embodiments. FIG. 10C depicts an example reporting form user interface, according to some embodiments.

FIG. 11 depicts a flow diagram of an example method for disseminating location-specific messages to various user devices in a selected geographic area, according to some embodiments.

FIG. 12 depicts a flow diagram of an example method for disseminating a location-specific message to a selected user device, according to some embodiments.

FIG. 13 depicts a flow diagram of an example method for presenting a location-specific message via a map-centric interface, according to some embodiments.

FIG. 14 depicts a block diagram illustrating an example computer system, according to some embodiments.

### DETAILED DESCRIPTION

Certain terms are used throughout this disclosure. Generally the following terms have the following meanings unless the context clearly necessitates an alternative meaning. As used herein, the term “digital sign” refers generally to a digital display device that is in a fixed location and can display specified visual content in response to a signal or command sent from a remote content source. Non-limiting examples of digital signs include digital billboards, advertising or way-finding kiosks, television screens, video display boards, etc. In many instances, digital signs will be positioned in public indoor or outdoor areas, such as roadways, malls, airports, office buildings, parks, theaters, or sports stadiums, etc. Because “digital signs” as contemplated in this disclosure are located in fixed location, this term is not intended to refer to mobile computing devices, such as smartphones, tablet computers, smart watches, etc. Further, “digital signs” are not intended to refer to devices that are “personal” computing devices, such as desktop computers. Examples of a remote content source controlling digital signs include a governmental entity displaying emergency information on a digital billboard, an entity that monitors traffic conditions and remotely sends traffic information to signs positioned along roadways, digital advertisers, etc. “Real-time video,” “live video,” “near live video,” and “video feed” includes both real-time video and near real-time video. “Video” is intended to include both video and still pictures. The term “governmental entity” includes a governmental or quasi-governmental organization, corporation, business, agency, or body; law enforcement, emergency medical services, fire department, or other first responders and emergency personnel; public and quasi-public utility providers and servicers; and the like. “Video camera” or “camera” means a device capable of capturing or delivering a moving image or a series of still images at relative time intervals (e.g. network or IP camera, dome camera, bullet camera, camcorder, etc.). “Video camera” is intended to include all video cameras regardless of image sensor (e.g. CCD (charge-coupled device), CMOS (complementary metal-oxide-semiconductor), megapixel, etc.), type (e.g. color, black and white, infrared, thermal, etc.), or compression standard (e.g. motion JPEG, MPEG-4, H.264, etc.). “Unilaterally” means without additional intervention by a third party. “Communication medium” includes any medium by which two or more computers or electronic systems may transfer information (e.g. wi-fi, wi-max (world interoperability for microwave access), wi-bro (wireless broadband), satellite, DSL (digital subscriber line), cable modem, Ethernet, coax, fiber-optic, Internet, LAN (local area network), WAN (wide area network), PAN (personal area network), cellular, super wi-fi, 3g and its progeny, 4g and its progeny, LTE (long term evolution), and any future communications standards, etc.).

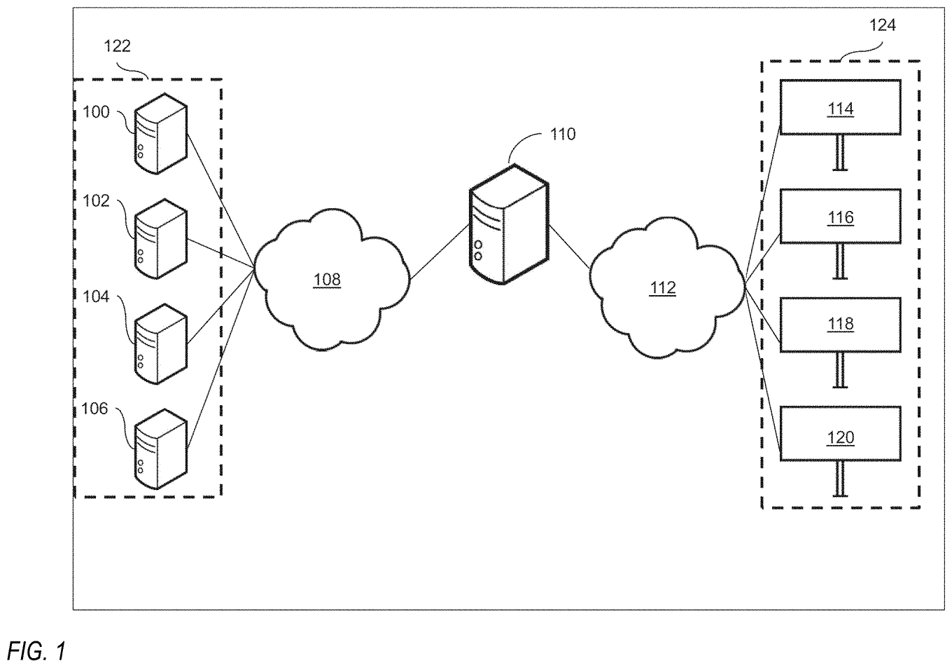

FIG. 1 depicts a graphical overview of one general system architecture that could be employed to implement the disclosed subject matter. Users (100, 102, 104, 106) (collectively, 122) would connect to a computer 110 via a communication medium 108. The computer would be connected to the digital signs (114, 116, 118, 120) (collectively, 124) via a communication medium 112. Although depicted here as two different communication mediums (108, 112) one or more could actually be employed. Also, although depicted here as four users (100, 102, 104, 106) and four digital signs (114, 116, 118, 120), any number is within the disclosed subject matter. Finally, although a single computer 110 is shown, one or more computers or servers could be employed. The digital signs 124 could also contain one or more video cameras 126 (not shown) intended to transmit video of the area surrounding a digital sign 124 and not necessarily video of the digital sign 124 itself. In some embodiments, a camera 126 directed at the digital sign 124 may be used for “proof of performance” (e.g., to demonstrate that an advertisement that should be displayed is actually being displayed). Such a camera 126 may in some embodiments provide low-frame-rate updates, because the content of digital sign 124 is typically expected to change only slowly. For example, a proof-of-performance camera might update at one frame per second, one frame per ten seconds, one frame per minute, one frame per ten minutes, or some other suitable frame rate. In some embodiments, a pair of cameras 126 may be used to show traffic conditions in each direction along the roadway from a digital sign 124. The digital signs 124 have circuitry to receive communication from the computer 110 in order to change the image, mode, or operation of the digital sign 124.

The users 122 could connect to the computer 110 through a myriad of devices including computers, smart phones, tablets, notebooks, laptops, personal digital assistants, or other computing style devices capable of connecting with the computer 110 via a communication medium.

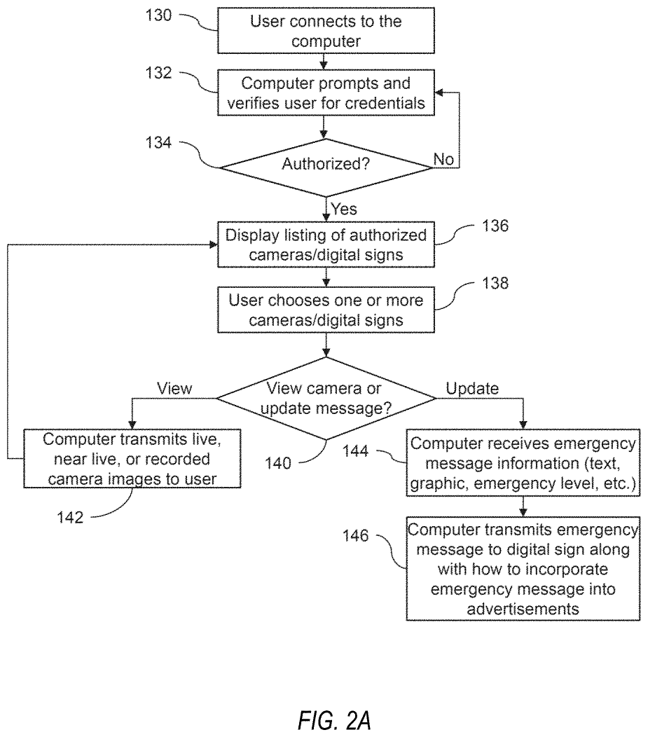

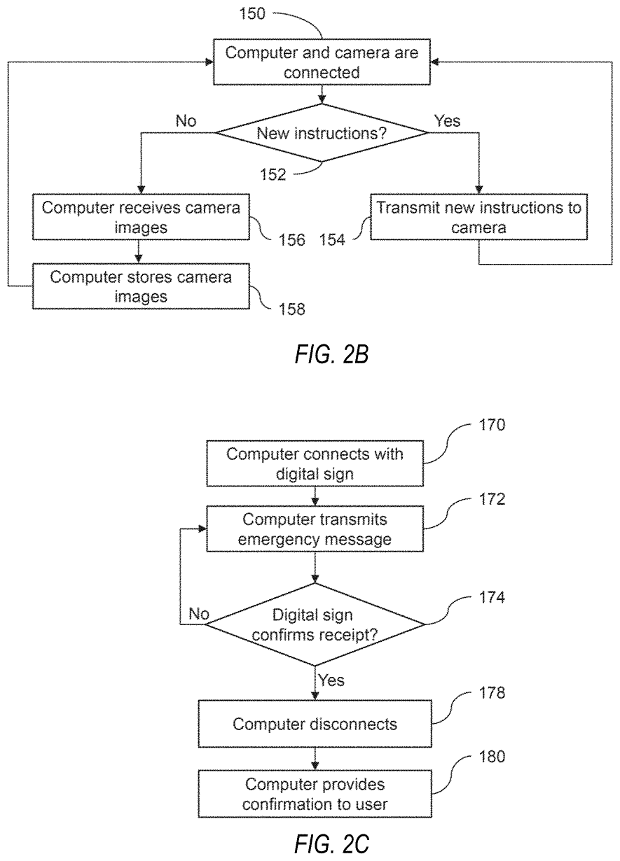

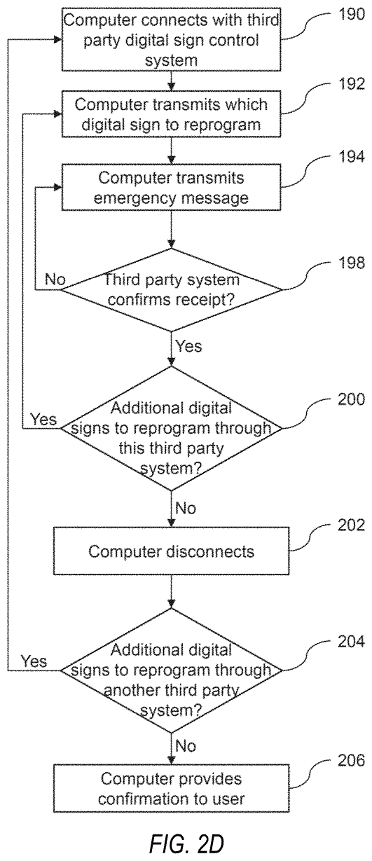

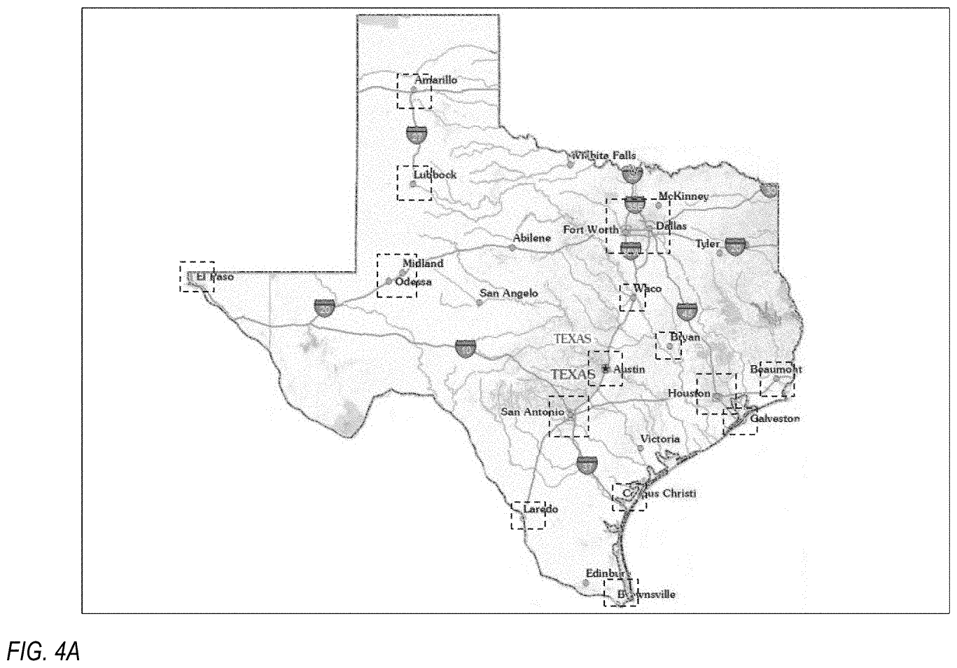

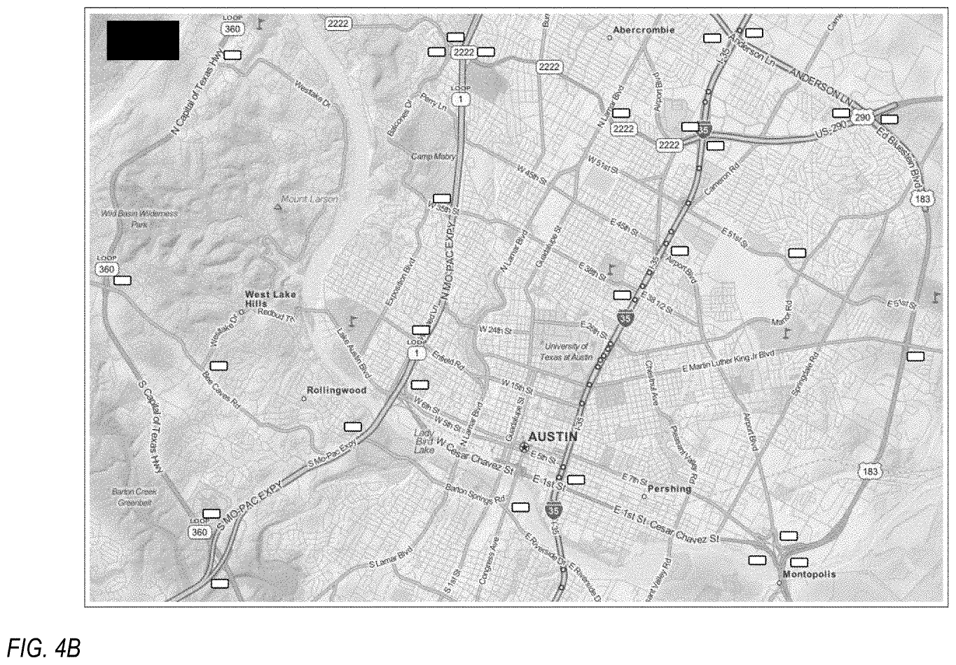

FIGS. 2a, 2b, 2c, and 2d depict various flow charts of the process and information flow of an embodiment of the disclosed subject matter. Referring first to FIG. 2a, which shows a possible information and process flow when a user 122 requests a video feed and or wishes to transmit an emergency message. First the user 122 connects to the computer 130 and enters its credentials 132. The computer 110 verifies the credentials 134 and if incorrect could prompt the user to re-enter its credentials 134. If the credentials are accepted, the computer 110 would transmit a listing of cameras or digital signs for which the user 122 is associated 136. In an alternative embodiment, a graphical map could be transmitted to the user to show the approximate location of cameras or digital signs in relation to structures, landmarks, roads, or the like and could allow the user 122 to zoom into a particular area (see FIGS. 4a and 4b). In yet another alternative embodiment, the user could search for a particular camera or digital sign using zip code, location, unique identifier number, etc.

The user could then select one or more cameras or one or more digital signs 138. If the user 122 selected to view one or more cameras 126 the computer 110 would transmit live, near live, or recorded images to the user 122. In one embodiment, the user could view multiple cameras at the same time (e.g. in a 2-up, 4-up, 8-up, n-up orientation) or in a rotation where each camera feed is displayed for a pre-set or user 122 configurable time period. Additionally, in one embodiment more specifically discussed in relation to FIG. 2b, the user 122 could pan, tilt, or zoom the camera or even place the camera into a “patrol” mode where the camera scans the viewable area repeatedly.

Continuing with FIG. 2a, if the user 122 chose to update the digital sign with an emergency message 140, the computer 110 would receive the emergency message information 144. The emergency message information should contain at least the emergency message to be delivered to the one or more digital signs, but could also include an emergency level, time period (e.g. display for the next hour), date and time of activation, date and time of deactivation, etc. The emergency message itself could contain one or more text messages or images. An emergency level could also be employed whereby the user 122 indicates the severity of the emergency. This in turn could trigger pre-set guidelines on: how often to display the emergency message in the normal advertising rotation or whether to completely pre-empt the normal advertising rotation; how long to display the message; etc. For example, the user 122 could choose between routine, urgent, and critical. Routine could be pre-defined as temporary incidents or “be on the lookout” style of messages such as traffic and construction matters or missing elderly. Urgent could be pre-defined as incidents that could put people, property, or animals in harm's way such as escaped convicts. Critical could be pre-defined as there is imminent risk to people, property, or animals such as hurricanes, tornados, chemical spills, evacuations, etc. Additionally, each of the emergency levels could have pre-defined display characteristics, such as:
Routine: display message after each advertisement, but do not preempt any advertising (e.g. Ad1, Emergency Message, Ad2, Emergency Message, . . . , Ad7, Emergency Message, Ad1 . . . ) for 30 minutes.
Urgent: display the message after each advertisement and reduce the display time of the advertisements (e.g. Ad1-4 seconds, Emergency Message-8 seconds, Ad2-4 seconds, Emergency Message-8 seconds, . . . ) for three hours.
Critical: display only the emergency message until affirmatively cancelled by the user.
   The preceding emergency levels are intended only as examples and any other names, classifications, time limits, preemption, and number of the foregoing could be employed and remain within the scope of this disclosure. In addition, to static images and messaging, streaming video or messages or moving video or messages could also be employed throughout this disclosure.

In one embodiment, the emergency message would be cycled/displayed until the initiating user 122 requested the message to cease. In another embodiment, the emergency message would be cycled/displayed for a pre-set time period (e.g. one hour; according to the emergency level) and if the user 122 desired the message to continue, the user 122 would have to affirmatively extend the time period (e.g. issue the same emergency message again; re-enter the time period; etc.).

Because multiple users could have access to a particular digital sign at any one time, it is possible to have two competing emergency messages. This could be addressed in several different ways. One example could be to allow only the message with the higher emergency level to be displayed, in effect preempting the “lower” level emergency message. In another example, both emergency messages could be cycled according to some pre-defined criteria similar to those of the emergency levels. In yet another example, the emergency messages could be ranked by user 122 (e.g. local emergency preempts state emergency).

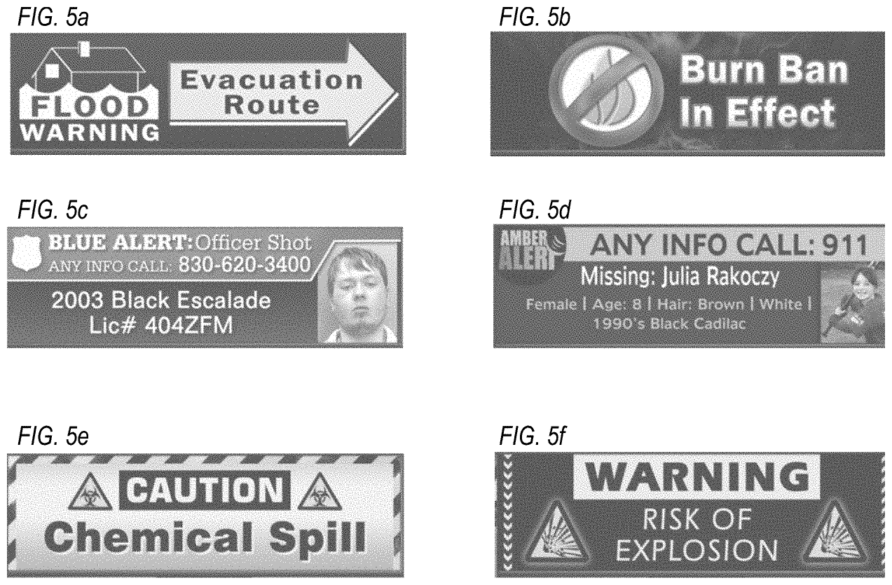

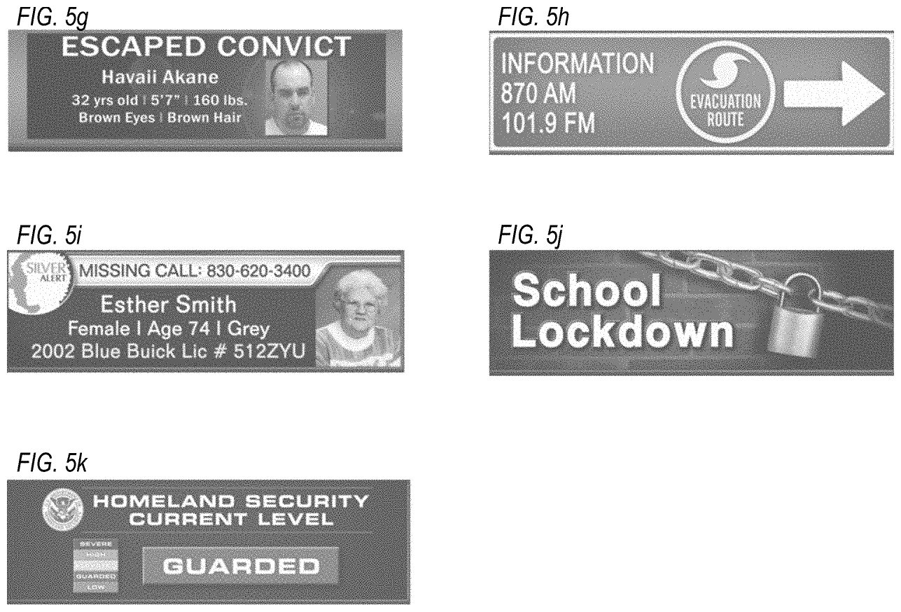

The emergency message information could be transmitted from the user to the computer 110 in a specific format containing the required information. In an alternative embodiment, the computer 110 could provide a “wizard” style interface guiding the user 122 through the required information (e.g. drop down boxes, fill in boxes, radial buttons, text boxes, image upload). In one embodiment, the computer 110 could provide templates such as those depicted in FIGS. 5a through 5k to assist the user 122 in creating the emergency message. Also, the computer 110 could provide the user access to previously issued emergency messages that were initiated by the user 122 (or in an alternative embodiment, that were issued by other users 122) to assist the user 122 in constructing an effective and clear emergency message.

Nevertheless, once the computer 110 receives the required emergency message information, the computer 110 would transmit the emergency information along with instructions on how the emergency message should be integrated into the pre-existing advertising rotation to the digital sign 146. In one embodiment the computer 110 would also log pertinent information about the emergency message which could include: the user's 122 name/login credentials, the time of the emergency message information transmission, which digital signs where included in the emergency message, confirmation the emergency message was successfully transmitted to the digital signs, confirmation the emergency messages was removed from the digital sign, etc.

Because there is always the potential for abuse with a system that permits a user to unilaterally display a message to the public, computer 110 could be configured to require confirmation of the proposed emergency message from another user 122 associated with the entity (e.g. supervisory approval). Although possible, it is important to note that this additional confirmation is not intended to be the owner or operator of the digital signs 124 but another person associated with the entity.

The computer 110 and camera 126 are connected via a communication medium. In one embodiment, the camera 126, or a local computer in relatively close proximity to the camera 126, could store the video feed or images from the camera 126 until sent or retrieved by the local computer 110. In an alternative or complimentary embodiment, the computer 110 could retrieve the video feed or images from the camera 126 itself (e.g. from the camera's 126 memory or via live feed) or the local computer in response to a user 122 request. In an alternative embodiment, the camera 126 or the local computer could transmit continuously to the computer 110. Referring now to the specific embodiment shown in FIG. 2b which depicts a flow diagram of the process and information transfer between the computer 110 and camera 126. The computer 110 is connected to the camera 150. If the computer 110 has updated instructions for the camera 152, the computer 110 transmits the new instructions to the camera 154. These instructions could include: changing the frame rate (e.g. 30 frames per second (“fps”), 15 fps, 1 fps, 0.1 fps, etc.); changing the resolution (1024×768, 640×480, 550 lines of resolution (“lor”), 400 lor, 1080p, 1080i, 480i, etc.); changing the color, contrast, skew, or other aspects of the image; changing the focus, pan, tilt, or zoom; etc.

If there were not new instructions, or the new instruction were previously transmitted, the computer receives or retrieves the camera 126 image 156 and stores the image 158 for archival and delivery to a requesting user 122. The addition of cameras 126 to the digital signs 124 adds an additional information gathering tool for users 122. For example, users 122 can evaluate the scene of an emergency before emergency responders arrive and convey pertinent information to those responders. Users 122 could monitor the progression or clean-up of an emergency and update the digital signs 124 accordingly. Users 122 could also review accidents and use the recorded footage for both crime prevention and crime solving. Additionally, real-time traffic flows, congestion, and other traffic statistics can be compiled, analyzed, and disseminated.

In addition to transmitting live, near live, or recorded video or images, the camera 126 in conjunction with software could perform other services such as performing traffic counts.

Referring now to FIG. 2c which depicts the direct transmission of emergency message information from the computer 110 to the digital sign 124. First, the computer 110 connects to one of the digital signs 170. The computer 110 transmits the emergency message information to the digital sign 172 and waits for confirmation that the digital sign 124 received the emergency message 174. If the digital sign 124 did not properly acknowledge the emergency message information, the computer 110 will retransmit the emergency message information. However, if the digital sign 124 acknowledges the emergency message information, the computer 110 disconnects 178 and provides confirmation to the user 122 that the emergency message information was properly delivered 180.

Referring now to FIG. 2d which depicts using a third party digital control system to transmit the emergency message information from the computer 110 to the digital sign 124. First, the computer 110 connects to the third party digital sign control system (e.g. a proprietary online or local software program used to connect with or reprogram a particular manufacturer's digital sign 124). This connection step 190 could include providing credentials to the third party digital sign control system or otherwise “logging into” the third party digital sign control system. The computer 110 then transmits which digital sign is intended to be reprogramed 192. The computer 110 then transmits the emergency message information in a format designed to be compatible with the third party digital sign control system 194. It is important to ensure that the format of the transmission is customized for the particular third party digital sign control system because each manufacturer's system is different.

The computer 110 waits for confirmation of receipt 198 and retransmits if receipt is not acknowledged. The computer then determines if there are additional digital signs 124 that require reprogram and that are associated with this particular third party digital sign control system 200. If there are, computer 110 repeats starting with 192. If there are no more digital signs 124 requiring reprogram from this particular third party digital sign control system, the computer 110 disconnects 202. If there are additional digital signs 124 requiring reprogram from alternate third party digital sign control systems 204 the computer 110 repeats from 190 for each additional third party digital sign control system. Once completed, the computer 110 provides confirmation to the user 122 that the emergency message information was properly delivered 206.

Some third party digital sign control systems may vary in the order of the above steps, may omit one or more of the above steps, or may need additional steps. The preceding is merely an example of one possible way of delivering the emergency message information to the digital sign 124 via a third party digital sign control system.

It is important to note that the disclosed subject matter can place users 122 in control of the emergency messaging capability of the digital signs 124 without additional owner/operator involvement. In effect, the user 122 has unilateral control over creating the emergency message, selecting the affected area, and delivering the emergency message without additional human interaction or owner/operator approval or consent. For example, traditional systems require a person to prepare the emergency message, identify the owner/operator of each digital sign 124, contact the owner/operator of each digital sign 124, and transmit the emergency message to the owner/operator. Then, the owner/operator has the option to post the emergency message, and if so, he or she must upload the emergency message to the digital sign 124 (which may include dispatching personnel to each digital sign 124). If the person desires to change the emergency message, the process must be restarted. Finally, at some point in the future, the person initiating the notification must contact the owner/operator to remove the emergency message and the owner/operator must actually take action to remove the emergency message.

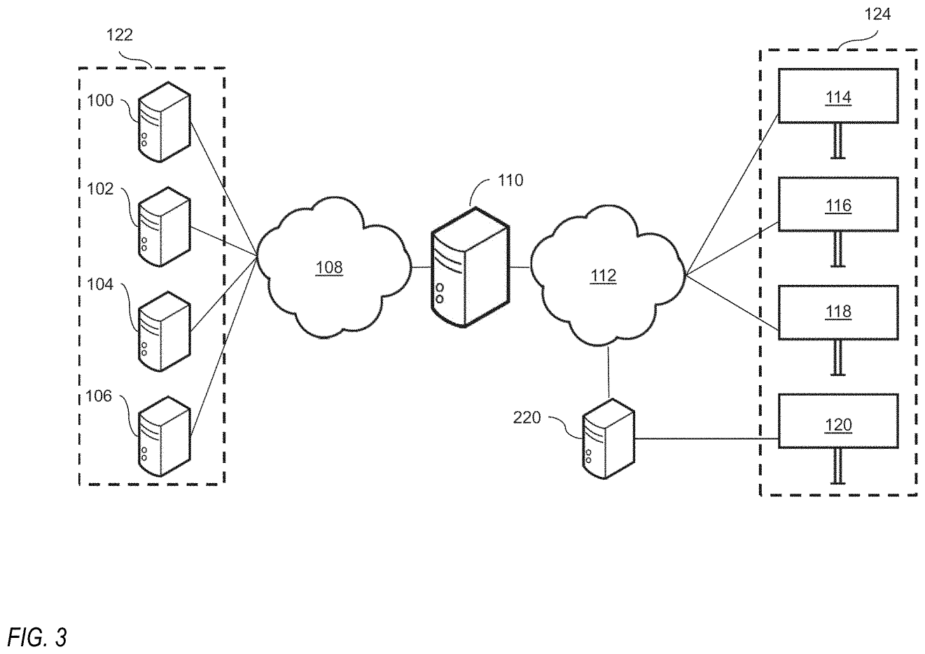

FIG. 3 depicts a graphical overview of a general system architecture that could be employed to implement the disclosed subject matter with the addition of third party digital sign control systems. This Figure parallels FIG. 1, but depicts the addition of third party digital sign control systems 220 where direct control of the digital signs 124 is not permitted or practicable. Although depicted here as a single third party digital sign control system 220 connected to a single digital sign 120, any number of third party digital sign control systems 220 could be included which any one of those third party digital sign control systems 220 could be connected to more than one digital sign 124.

Turning now to FIGS. 4a and 4b which depict exemplary graphical maps that could be transmitted to the user 122 to show the approximate location of cameras or digital signs in relation to structures, landmarks, roads, or the like. More specifically, FIG. 4a depicts a graphic of the State of Texas with geographically related cameras 126/digital signs 124 grouped in boxes. These boxes are one way to allow a user 122 to drill down and select one or more cameras 126 or digital signs 124. Referring now to FIG. 4b depicting an exemplary graphic of downtown Austin, Tex. showing individual cameras 126 and digital signs 124. Although shown as static images, the system could allow users 122 to arbitrarily reposition the map or zoom into locations.

The system could also allow each user 122 to create its own boxes or groupings of cameras 126 or digital signs 124. Additionally, the system could allow the user 122 to draw a box on the map to select all cameras 126 or digital signs 124 within the box. The system could also permit the user 122 to click on particular roads/streets/highways/etc. to bound a particular area and thereby select all cameras 126 or digital signs 124 adjacent to or within the particular area. Yet another embodiment could allow the user 122 to pick a particular point on the map and select all cameras 126 or digital signs 124 within a certain radius of the point. Additionally or alternatively to the foregoing, zip codes, area codes, GPS, or other coordinate/location systems (e.g. latitude and longitude) could be employed. Clearly, other methods of selection could also be employed (e.g. pick a point and predict fall out based on current or traditional wind patterns; auto-select based on storm track; etc.). The result of the foregoing to allow the user 122 the ability to confine the emergency notification to a particular geographic area.

FIGS. 5a through 5k depict exemplary emergency messages. It should be noted that the exemplary emergency messages could be in color although depicted here as greyscale.

Because of the nature of the disclosed subject matter for disseminating emergency messages, it is important to have continual power and communications. As such, one should consider having redundancy and back-up power. For example, redundancy could include having multiple computers 110 and multiple computers 110 in geographically remote areas relative to each other. Uninterruptable power supplies or other redundant power technologies could be employed both at the computers' 110 location and the digital sign's 124 location. Finally, one could employ redundant communication mediums to and from each geographic location (e.g. computers 110, digital signs 124, third party digital sign control systems, etc.).

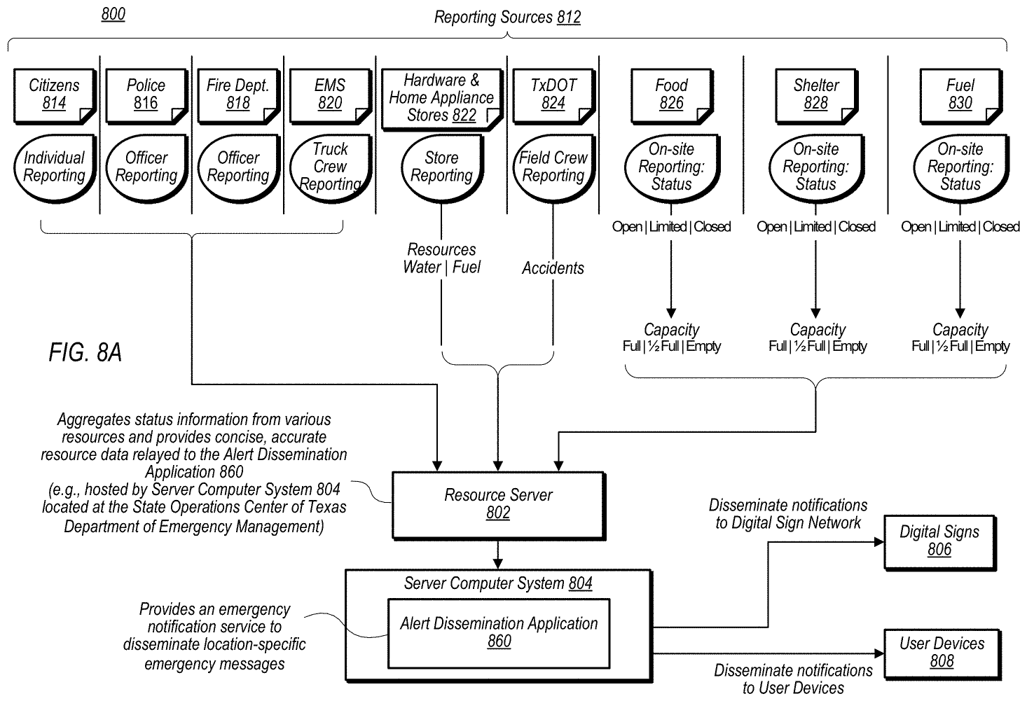

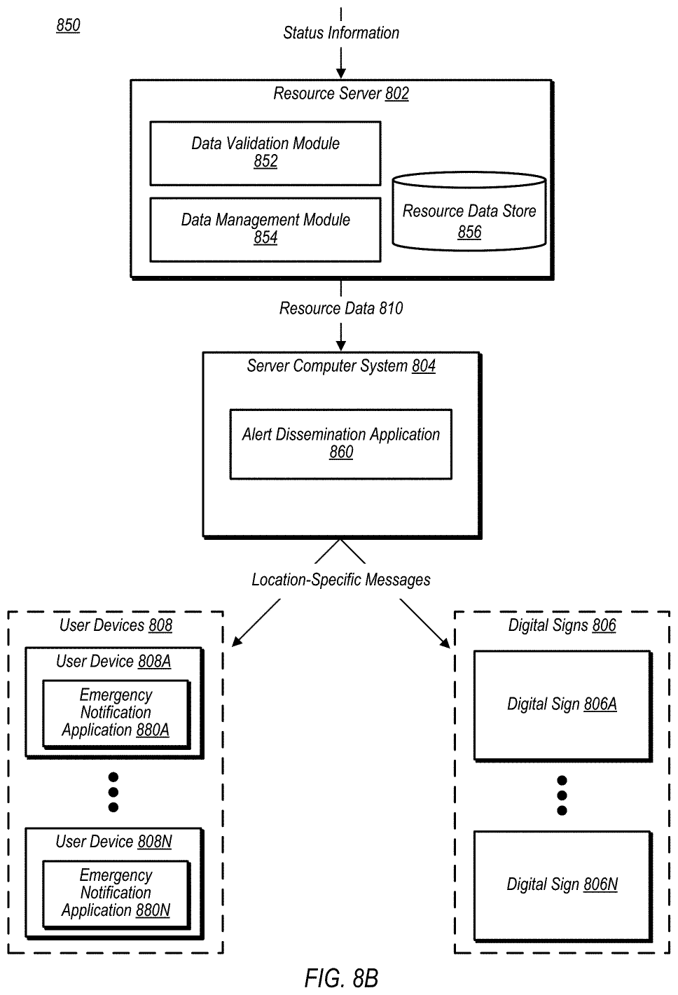

In various embodiments, as described in more detail below with reference to FIGS. 8A-13, the disclosed systems and methods may include obtaining resource data from a resource server system via one or more communications mediums. The resource server system is generally a database that is populated and updated to show the location of certain resources throughout an area. As an example, a database may store the location and status of stores with food, water, wood, fuel, or other supplies or the location of available lodging. As was painfully evident during the evacuation of the Texas Gulf Coast in September 2005 ahead of hurricane Rita, such information can literally make the difference between life and death.

In various embodiments, as described in more detail below, a given digital sign 124 may be associated with a particular geographic region and configured to display information for that region. In other words, information from the resource server system may be geographically linked to the relevant region(s) and provided to the appropriate digital signs 124. For example, the relevant geographic region for various types of resources might encompass signs within a given distance of the facility (e.g., as the crow flies); signs within a given distance of the facility along roads; signs on the same road as the facility and within a given distance; signs within the same city, county, or state as the facility; all signs within an emergency zone; etc. The relevant distance for such geographical boundaries might be any suitable distance, such as 0.5 miles, 1 mile, 2 miles, 5 miles, 10 miles, 20 miles, 50 miles, etc.

Accordingly, travelers may be provided with accurate and up-to-date information about the availability of services they need in a geographically accessible area. Alternatively or additionally, the system may be configured to display on a particular sign information regarding all travel data within a relevant area or geographical region of that sign. Accordingly, each sign may display different information corresponding to the travel data relevant to the particular geographical area relevant to that sign. Such information may be displayed alongside advertising information, or it may in an emergency situation displace the advertising information.

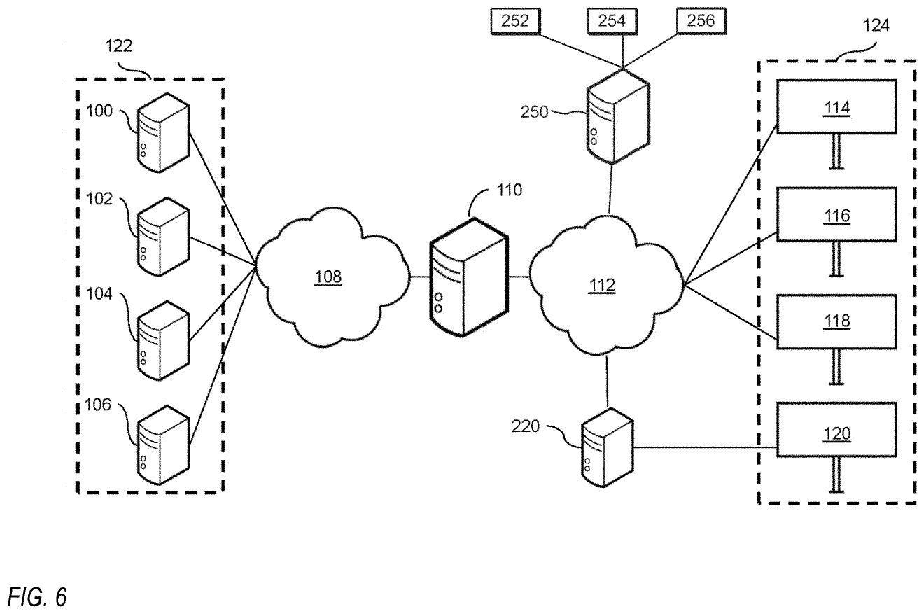

FIG. 6 depicts a high-level overview of one embodiment of this disclosure. The system of FIG. 6 is broadly similar to what is shown in FIG. 3, but with the addition of resource server 250, which may be connected to computer 110 via, e.g., communication medium 112. One of ordinary skill in the art will recognize that resource server 250 need not be implemented in a separate physical machine/machines, but may in some embodiments reside within computer 110.

As described in more detail below, resource server 250 may receive resource information updates from sources 252, 254, and 256. Computer 110 may then cause such travel data to be displayed upon the relevant ones of digital signs 124, according to various embodiments. For example, in an emergency, travelers may need gas. Accordingly, computer 110 may cause one or more of digital signs 124 to display information about which gas stations nearby have gas available for sale. Similar information regarding other travel data may also be displayed as appropriate and as desired.

Although described and shown in many examples as billboards outside along roadways, the disclosure should not be read in a limiting sense and indoor, outdoor, on-premises, off-premises, or other digital signs are intended to be included within the scope of the disclosure. Advertising or way-finding kiosks (e.g. in a mall or other relatively populated indoor or outdoor area) are intended to be included in the foregoing. Additionally, as described in more detail below with reference to FIGS. 8A-13, the disclosed systems and methods may be used to disseminate messages to computer systems other than digital signs, such as mobile user devices (e.g., smartphones, tablet computers, smart watches, etc.) or in-vehicle computer systems.

As was described above, well-placed digital signs 124 have the ability to convey very detailed and pertinent emergency information directly to the particular location effected by the emergency situation. The old adage “a picture is a worth a thousand words” proves especially true in an emergency situation and digital signs 124 provide a way for users 122 to quickly and efficiently provide text and graphics directly to affected parties.

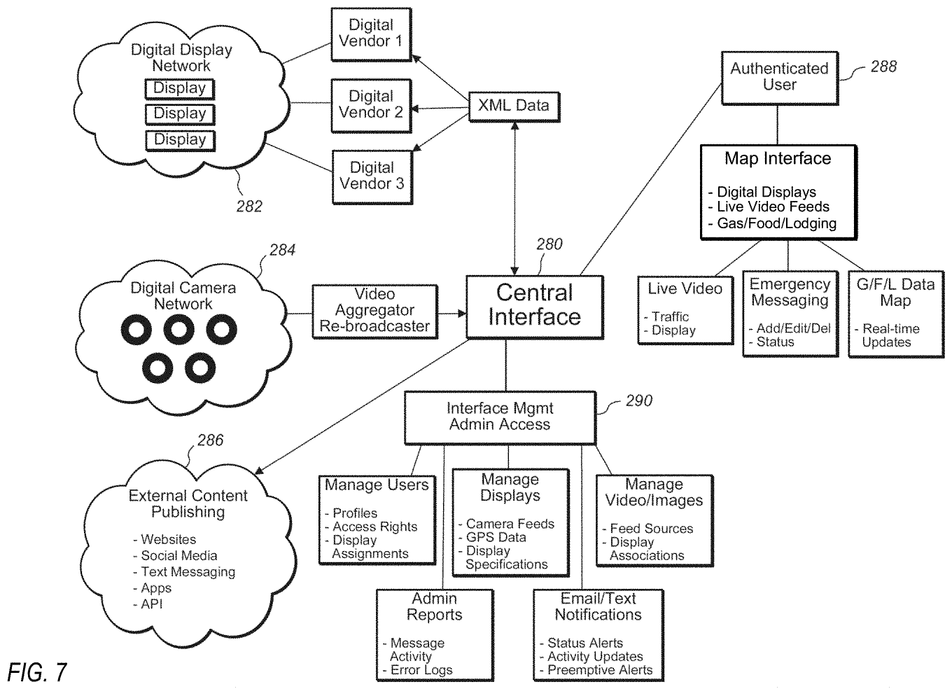

FIG. 7 shows an interface diagram according to an embodiment of this disclosure. As shown in FIG. 7, central interface 280 may be provided to allow access to various aspects of this disclosure. Some of these aspects may be broadly grouped as digital display network 282, digital camera network 284, external content publishing 286, authenticated user interface 288, and interface management administrator access interface 290. According to some embodiments, central interface 280 may be a web-based interface.

According to some embodiments, central interface 280 enables publishing of emergency and non-emergency messaging, including text and graphics, which may be published to the digital display network 282 or any number of 3rd party destinations, such as external content publishing 286 (see below for more information regarding an interface API for external publishing). Digital display network 282 may in some embodiments be accessed via an XML interface to various 3rd-party digital sign interfaces (e.g., Visiconn and other vendors). Messages may be created from pre-defined templates in a template library or by using custom graphics and text uploaded by the user. In various embodiments, some types of messaging may include:
Weather Alerts
Homeland Security and Terrorist Alerts
Blue Alerts
Silver Alerts
Amber Alerts
Evacuation Information
Hazardous Conditions
Environmental Hazards
Community-service Messages

As shown in FIG. 7, digital display network 282 may be capable of receiving real-time emergency messaging from central interface 280. Any display connected to a publishing system capable of receiving content from the interface may be included in the network, in various embodiments.

A network of digital cameras capable of sending live video feeds to the video aggregation software is also shown in FIG. 7 as digital camera network 284. Video feeds may become available through the interface across a variety of devices, including desktop computers, smartphones, tablets, etc.

According to some embodiments, a map-centric user interface may be provided, e.g., via authenticated user interface 288. In this embodiment, the map-based interface is the primary user interface for interacting with digital displays, video feeds, and data. This interface may consist of custom icons, windows, and data overlaid on an interactive map (e.g., a map provided via Google Maps®). This may include the ability to upload custom or predefined messaging graphics and text to content recipients, including digital displays, social networks, 3rd party websites, email and text message recipients.

According to some embodiments, gas/food/lodging (GFL) data may be provided via a proprietary database of services. This may be used in emergency situations to assist local and state emergency management entities in identifying resources. This data may be provided through the map interface and include detailed, real-time information about the status of each resource, such as fuel or food availability, along with the location and contact information of each product/service provider.

Real-time travel and weather information, such as road conditions, traffic flow, travel times, accidents, severe weather warnings and updates may further be provided. All real-time information may be available through the map interface as well as through the publishing system, which may be disseminated to the display network or any 3rd parties that request access to this information.

An interface API for external publishing via external content publishing 286 may also be provided. This may be implemented as an external interface to the publishing system, which may allow for content requests/subscriptions from 3rd parties, such as other websites. 3rd party entities that subscribe to content updates from the publishing system may receive relevant emergency messaging and graphics in real-time.

This external interface may also provide for “pushing” content to 3rd parties, such as social networks (Facebook®, Twitter®, etc.). Content updates may be sent to each 3rd party according to the specifications required by each receiving system. For example, the Twitter® API may be used to send content to Twitter® accounts that have subscribed for updates. 3rd parties may include social networks, email accounts, wireless carriers (for text/media messaging), instant messaging networks and other real-time messaging systems or information systems that may be in use by state and local emergency management agencies.

Further, interface management administrator access interface 290 may be provided via central interface 280. This may in various embodiments allow user management, display management, video/image management, administrative reports, or email/text notifications.

As noted above, in various instances, the management and distribution of resources during an emergency event, such as a hurricane, tornado, etc., may be overseen or assisted by one or more governmental entities. As one non-limiting example, in the State of Texas, the Texas Department of Emergency Management (“TDEM”)—itself a part of the Texas Department of Public Safety (“DPS”)—coordinates a state emergency management program that enables state and local government officials to respond to and recover from emergency events. For example, the TDEM operates a State Operations Center (“SOC”) that serves as a facility from which emergency events may be monitored. Various entities, such as governmental agencies or private organizations, may have stations within the SOC from which they may perform emergency monitoring and response operations. In various embodiments, the disclosed systems and methods may be used by such government entities (or non-governmental organizations) to oversee the status of various resources (e.g., water, gasoline, emergency medical services, etc.) and distribute location-specific messages, such as emergency messages, to citizens or emergency personnel (e.g., police officers, firefighters, EMS crews, etc.) regarding the status of these resources during times of emergency. For example, in various embodiments, the disclosed systems and methods may be used to send location-specific emergency notifications to one or more user devices (such as smartphones, tablet computers, smart watches, in-vehicle computer systems, etc.) based on their current location. Additionally, in various embodiments, the disclosed systems and methods may be used to cause location-specific emergency notifications to be displayed on selected digital signs, such as roadway billboards, electronic kiosks, etc.

As one non-limiting example, consider an instance in which a particular geographic area is affected by an emergency event, such as a hurricane. In this situation, it is vital for residents to know the location and status of resources, such as gasoline, water, evacuation routes, traffic conditions, etc., so that they can respond appropriately to the emergency event. In such an instance, the disclosed systems and methods may be used, for example by TDEM personnel, to monitor location-specific resource data that indicates the status of one or more resources in the affected geographic area. In various embodiments, the government official(s) may use the disclosed system to send location-specific notifications to select ones or groups of user devices or digital signs, based on their respective locations relative to the emergency event. As one example, the government official may select, via a map-centric interface, the geographic area that is, or will likely be, affected by the emergency event. The system may then identify and send emergency notifications to the various user devices and digital signs that are currently located within that selected geographic area. In various embodiments, the content of these emergency messages may, of course, vary depending on the nature of the emergency event and the particular device to which they are sent. For example, in some embodiments, the disclosed system may send, to the user devices, data that is usable to populate an interactive map with information indicative of the location and status of various resources, such as gas, evacuation routes, hazard zones, etc. Similarly, in some embodiments, the disclosed system may cause location-specific messages to be displayed on some or all of the digital signs in the selected geographic area. In various embodiments, this content may include a graphical map that indicates the location and status of various resources, such as road conditions, evacuation routes, fuel and lodgings availability, etc.

Thus, in various embodiments, the disclosed systems and methods may be used to disseminate timely and location-specific emergency notifications to those in need, thereby improving the operation of the emergency notification system and the emergency notification process as a whole.

Referring now to FIG. 8A, a block diagram 800 illustrating a system for distributing location-specific emergency notifications is shown, according to some embodiments. In the embodiment of FIG. 8A, diagram 800 includes resource server 802, server computer system 804, one or more digital signs 806, and one or more user devices 808. Note that, although shown in direct communication, one or more of resource server 802, server computer system 804, the user devices 808, and the digital signs 806 may be connected via one or more communication networks (not shown for clarity).

In FIG. 8A, server computer system 804 is shown executing alert dissemination application 860. In various embodiments, alert dissemination application 860 (also referred to as an “emergency management application”) provides an emergency notification service that may be used (e.g., by a governmental entity, such as the TDEM) to manage and distribute information regarding the status and availability of various resources to user devices 808 and digital signs 806. For example, in various embodiments, the alert dissemination application 860 is operable to disseminate emergency messages to various user devices 808 and digital signs 806 based on their respective locations. In some instances, these emergency messages may be notifications intended to inform and warn people of emergency events affecting the area in which they are located. In other instances, these emergency messages may be sent to emergency personnel (e.g., police officers, fire department personnel, etc.) to provide information and instructions to facilitate emergency response operations (e.g., deployment instructions).

FIG. 8A further includes resource server 802, which, in various embodiments, is operable to aggregate resource data 810 from various reporting sources 812. For example, FIG. 8A includes various reporting sources 814-830 (referred to generally as reporting sources 812) that may report the status of their respective resources to the resource server 802. In various embodiments, the resource server 802 is operable to aggregate, verify, and validate this information and then provide concise, accurate resource data 810 to the server computer system 804 such that it may then be distributed, by the alert dissemination application 860, to various user devices 808 and digital signs 806.

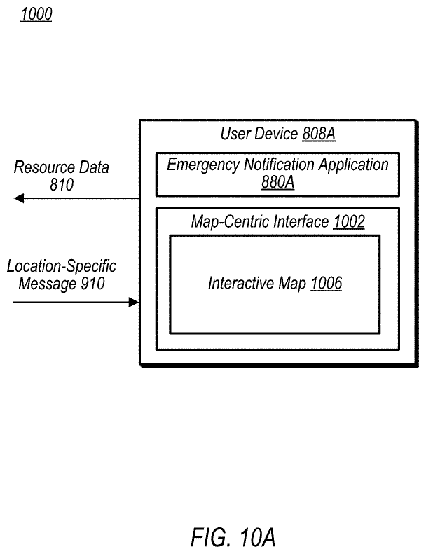

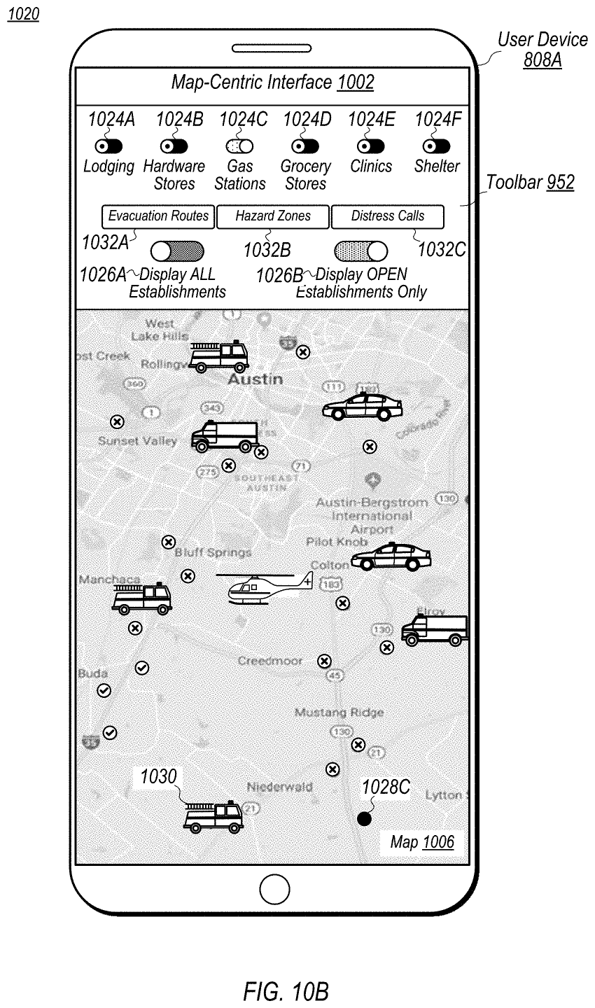

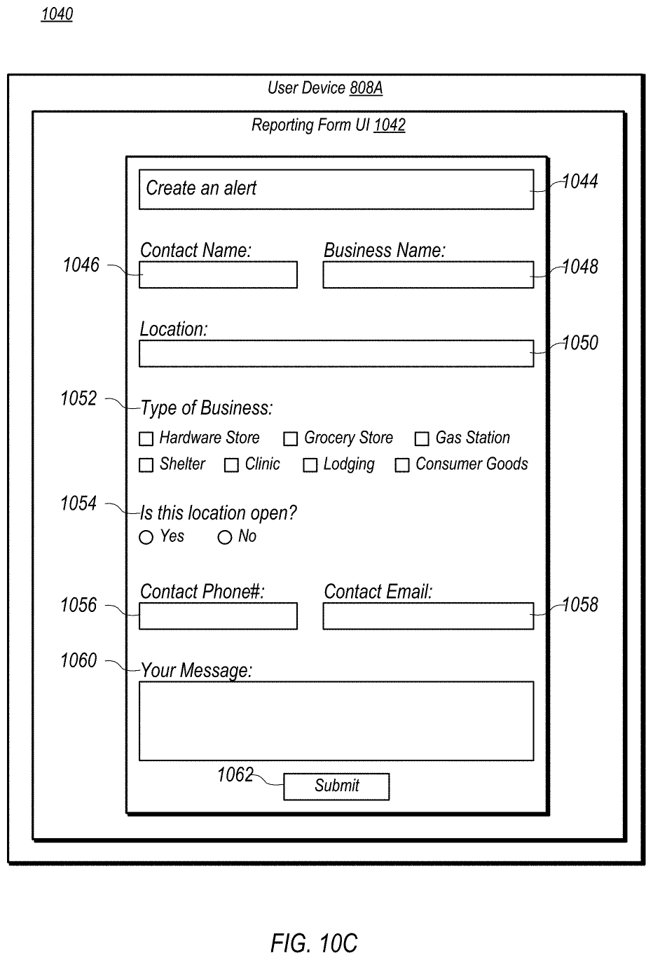

Note that the entities included in reporting sources 812 may vary, according to various embodiments. For example, in the depicted embodiment, reporting sources 812 include individual citizens 814 and various emergency and government personnel, such as police 816, fire department personnel 818, EMS crew 820, and Department of Transportation (“DOT,” such as the TxDOT) personnel 824. In various embodiments, each of these reporting sources 812 may provide information regarding the status and availability of various resources. Citizens 814, for example, may provide updates regarding the status of resources or of an emergency event based on their first-hand experiences, as explained in more detail below with reference to FIG. 10C. As one non-limiting example, a citizen 814 may provide updated status information regarding an emergency event (e.g. a car accident) via an emergency notification application 880 on their user device 808. Similarly, the various emergency and government personnel may report the status of their respective services, such as their location and availability (e.g., available, en route, in progress, etc.) to the resource server 802. For example, an EMS crew 820 may provide an indication to the resource server 802 that it is en route to service a request for emergency medical services at a particular location. As another example, a DOT field crew at the site of a car accident may report on the status of the accident (e.g., any injuries, expected traffic delays, etc.) to the resource server 802. In some embodiments, the emergency services personnel may report their status and location using an emergency notification application 880 installed on their mobile devices or in their vehicles. For example, in some such embodiments, the emergency notification application 880 may enable the emergency services personnel to manually supply this update information or may be configured to periodically provide location information to the resource server 802.

Additionally, in various embodiments, reporting sources 812 may include individuals or businesses that provide various resources such as food, shelter, fuel, and various other resources. As non-limiting examples, the reporting sources 812 of FIG. 8A include hardware and home appliance stores 822, food providers 826 (such as restaurants, grocery stores, etc.), shelter providers 828, and fuel providers 830, each of which may provide resource data 810, to resource server 802, indicating a status and availability of their respective resources. For example, various hardware and home appliance stores 822 may report the status of various resources such as water, fuel, generators, etc. Similarly, food providers 826, shelter providers 828, and fuel providers 830 may report their respective status (e.g., open, limited, closed) and availability (full, ½ full, empty, etc.). As non-limiting examples, the reported status information may include such information as the number of rooms available at a hotel; whether a gas station has gasoline or diesel available; whether a gas station has various grades of gasoline available; how much of each type of fuel a gas station has available; whether a grocery store has food or water available; how much food or water a grocery store has available; whether a grocery store is open for business; whether a restaurant has food or water available; how much food or water a restaurant has available; whether a restaurant is open for business; and other information describing the availability or supply of various travel services.

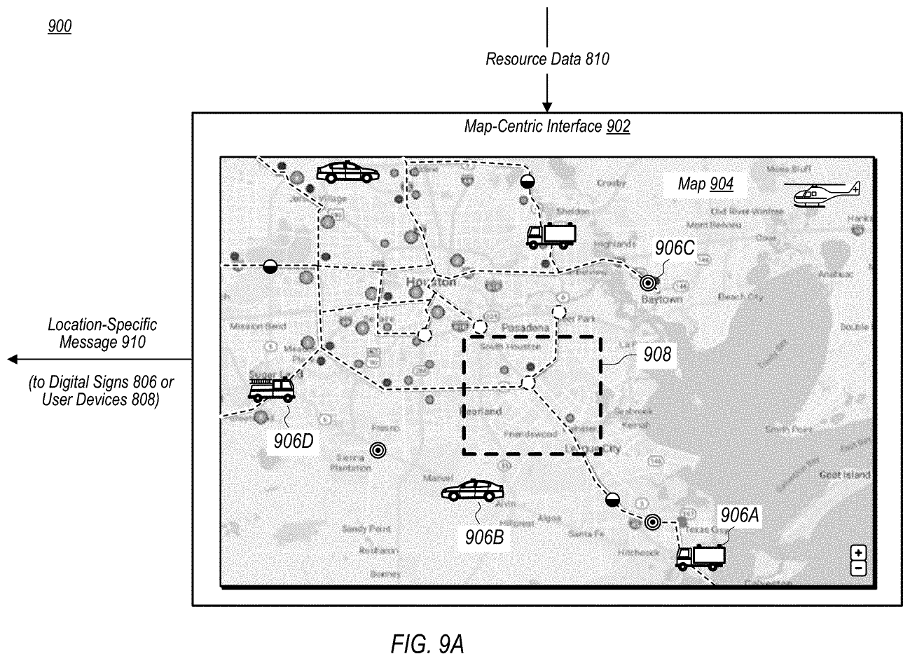

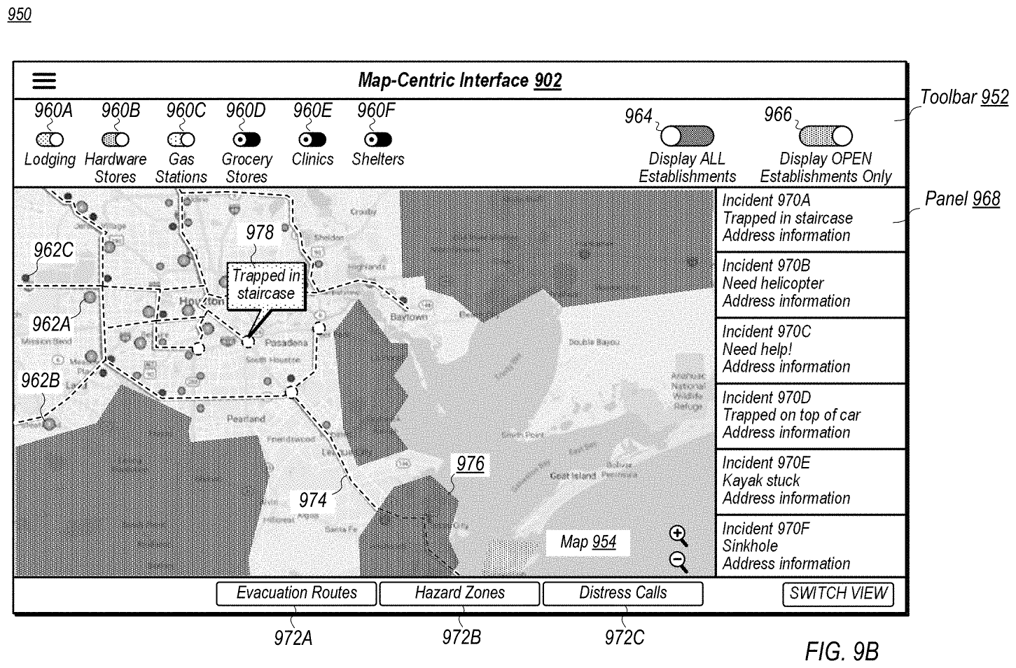

Note that, in various embodiments, one or more of the reporting sources 812 may proactively provide status information to the resource server 802 at a periodic interval (e.g., once per day, once per hour, every 10 minutes, etc.). For example, in some embodiments, resource server 802 (or alert dissemination application 860) may provide a web-based interface through which the various reporting sources may provide the status information (e.g., periodically, in real-time or near real-time, etc.) to the resource server 802. Additionally, in some embodiments, various reporting sources 812 may provide status information to the resource server 802 using a reporting form provided by a software application (e.g., emergency notification application 880, described in more detail below). In various embodiments, either of the web-based interface or the dedicated software application may provide a map-centric interface and a reporting form to facilitate the quick and easy communication of the status information from the reporting sources 812 to the resource server 802. (Note that, in some embodiments, telephone calls or other methods may be used to update the travel information, although typically such methods may not provide real-time information. For example, an operator associated with the resource server 802 may call or email various reporting sources 812 at specified times to request that they update their information in the travel database.) Further note, however, that in some embodiments, one or more of the reporting sources 812 may provide such status information in response to a request from the resource server 802 or alert dissemination application 860. For example, as described in more detail below with reference to FIG. 9A, the resource server 802 may send requests to various ones of the reporting sources 812 based on their respective locations relative to a geographic area for which an emergency notification is being sent.

Turning now to FIG. 8B, block diagram 850 depicts a more detailed view of the resource server 802, server computer system 804, user devices 808, and digital signs 806, according to some embodiments. As shown in FIG. 8B, resource server 802 aggregates status information regarding various resources (e.g., food, fuel, emergency services personnel, etc.) from the various reporting sources 812. In the depicted embodiment, resource server 802 includes data validation module 852, which, in various embodiments, is operable to ingest and validate various items of location-specific resource information that it receives from the various reporting sources 812. In some embodiments, for example, this validation process may include verifying that the reported data is provided in a correct format, includes all relevant fields, that none of the reported values exceed a predetermined range (such as a report that a gas station has a negative quantity of gasoline, for example), etc. Further, in some embodiments, data validation module 852 may require that some or all of the resource information be verified by at least one source (other than the reporting source) before those items of location-specific resource data 810 will be stored in the resource data store 856.

Resource server 802 of FIG. 8B further includes data management module 854, which, in various embodiments, is operable to manage the items of location-specific resource data 810 stored in the resource data store 856. In various embodiments, resource data store 856 may be implemented as any of various suitable data stores. For example, in some embodiments, resource data store 856 is implemented as a database, such as a MySQL database. Note, however, that this embodiment is provided merely as an example and is not intended to limit the scope of the present disclosure. For example, in other embodiments, any other suitable data store or database technique may be used. In various embodiments, data management module 854 is operable to service requests for resource data from the server computer system 804. For example, as shown in FIG. 8B, resource server 802 may provide location-specific resource data 810 to the server computer system 804.

In various embodiments, the server computer system 804 executes an alert dissemination application 860 that is operable to disseminate location-specific emergency notifications to user devices 808 and digital signs 806. For example, as described in detail above with reference to FIG. 2a, the alert dissemination application 860 may be used to cause location-specific messages to be displayed on any one or more of the digital signs 806 within a network of digital signs. For example, in some embodiments, digital signs 806A-806N may correspond to the digital signs 124 of FIG. 1. Further, in various embodiments, the alert dissemination application 860 may be used to send location-specific emergency notifications to any number of user devices 808. For example, in various embodiments, a governmental entity or private emergency notification organization may use the alert dissemination application 860 to provide an emergency notification service that disseminates location-specific emergency notification messages to digital signs 806 and user devices 808. (Note that, in some embodiments, access and use of the alert dissemination application 860 may be limited to users that belong to a governmental entity or private emergency notification organization that is authorized to disseminate emergency notification messages. In some such embodiments, authorization to access the alert dissemination application 860 may be verified using any of various suitable techniques, such as user credentials, two-factor authentication, etc.) In some embodiments, users of user devices 808 can elect to receive location-specific emergency notifications by installing an emergency notification application 880 on their user device 808 (and, optionally, establishing a user account with the entity providing the emergency notification service). As described in more detail below with reference to FIGS. 10A-10B, the emergency notification application 880, in various embodiments, is operable to receive and display these location-specific notifications that it receives. For example, in some embodiments, the application 880 is operable to provide a map-centric interface to the user that is populated with information indicative of the status of one or more resources in the geographic area in which the user device is currently located.

Note that, in some embodiments, the server computer system 804 is also operable to ingest and validate various items of location-specific resource information that it receives from the various reporting sources 812, either instead of or in addition to the resource server 802. For example, in some embodiments, the server computer system 804 may include (e.g., as part of the alert dissemination application 860) one or more elements of the resource server 802, such as a data validation module 852, data management module 854, or resource data store 856. In such embodiments, the server computer system 804 may be operable to both collect and validate the location-specific resource information from the various reporting sources 812 in addition to disseminating the location-specific emergency messages to various user devices 808 or digital signs 806. Further note that, although shown separately in FIGS. 8A-8B, resource server 802 and server computer system 804 may be implemented either as separate systems or as part of one system, according to various embodiments. For example, in some embodiments, some or all of the components of the resource server 802 and server computer system 804 (e.g., data validation module 852, data management module 854, resource data store 856, alert dissemination application 860, etc.) may be provided by one or more computer systems located at a single physical location (e.g., a SOC facility). In other embodiments, however, one or more of these components may be hosted by one or more computer systems located at a remote physical location (e.g., located remotely from the SOC facility), such as a datacenter.

Additionally, note that, although only a single instance of alert dissemination application 860 executed by a single computer system is shown in the embodiments of FIGS. 8A and 8B, this simplified example is provided merely for clarity. In some embodiments, any suitable number of instances of the alert dissemination application 860 may be executed on any suitable number of computing devices. For example, in some embodiments, alert dissemination application 860 may be hosted by one or more server computer systems 804 located at a State Operations Center facility or other facility. In other embodiments, however, alert dissemination application 860 may be hosted by one or more computer systems located remotely from the SOC. For example, in some embodiments, alert dissemination application 860 may be hosted in a cloud environment on one or more remote server systems (e.g., located in a datacenter) and accessed by users (e.g., users associated with a governmental entity or emergency notification service) via a web-based portal or a standalone software application. Additionally, note that, in some embodiments, users may access the alert dissemination application 860 from computer systems that are located either at the SOC facility (e.g., on computer terminals physically located at the SOC) or from computer systems that are located remotely from the SOC (e.g., at an SOC-approved location that is deemed to meet the requisite physical- or network-security precautions), whether the alert dissemination application 860 is hosted at the SOC itself or by remote computer systems, as noted above.

Referring now to FIG. 9A, a block diagram 900 depicts a map-centric interface 902 (also referred to herein as a “dashboard” 902) that may be used to facilitate the dissemination of location-specific emergency notifications from alert dissemination application 860 to various user devices 808 or digital signs 806, according to various embodiments. In various embodiments, map-centric interface 902 may be provided to user (e.g., a governmental or non-governmental operator using alert dissemination application 860 at an SOC facility) and may be usable to selectively distribute location-specific emergency notifications. As noted above, in various embodiments, map-centric interface 902 may be provided by alert dissemination application 860 as it is executed by the server computer system 804. As noted above, in some embodiments, the server computer system 804 may be located at a SOC facility from which governmental or non-governmental personnel may distributed location-specific emergency notifications to selected user devices 808 or digital signs 806. For example, in some embodiments, various agencies or organizations will have designated stations within the SOC from which they may use the map-centric interface 902 to send location-specific emergency messages. In some embodiments, each of these different user groups (e.g., agencies or organizations) may be presented with a dashboard 902 that is customized for that particular user group.

As described above, the disclosed systems and methods may improve a user group's ability to disseminate timely and location-specific emergency notifications to groups of users, improving the emergency notification and response process as a whole. Consider, as one non-limiting example, a situation in which a police official needs to monitor the location and status of numerous police officers and deploy them to various emergency locations in an efficient manner. Previously, in such an instance, the police official would be required to call or otherwise communicate with each officer individually, requiring considerable time and potentially resulting in delayed deployment of police officers to emergency situations. In various disclosed embodiments, however, the alert dissemination application 860 may be used to quickly and efficiently monitor, communicate with, and deploy police officers (or any other emergency response personnel) to the appropriate locations. For example, in some embodiments a police department may have a designated station within a SOC facility, from which a police official may monitor the location and status of various police officers, each of which may carry a user device 808 (e.g., in the form of a smartphone, tablet computer, computer system within a squad car, etc.) executing the emergency notification application 880. In such an embodiment, the police official may use the dashboard 902 to view the location and status of all of the police officers in the area displayed on the map-centric interface 902. Further, in various embodiments, the police official may use the dashboard 902 to select individual ones or groups of police officers (e.g., based on their location as depicted on the map-centric interface 902) and send information or messages to the officers as part of emergency response operations. For example, the police official may use the map-centric interface 902 to send messages to the emergency notification applications 880 of the user devices 808 of the officers, enabling the officers to be deployed to a selected location to assist in emergency response efforts in a manner that is faster and more efficient than previously possible.

As shown in FIG. 9A, the alert dissemination application 860 obtains location-specific resource data 810 from the resource server 802. In various embodiments, this location-specific resource data 810 indicate the status of one or more resources (e.g. gas, food, water) within a geographic area, such as a state, a county, the city, or any other suitable geographic demarcation. Note that, in some embodiments, this location-specific resource data 810 may be obtained by retrieving the data from the resource server 802 on an as-needed basis. That is, in some embodiments, the alert dissemination application 860 may retrieve the resource data 810 from the resource server 802 as an instance of that application 860 is initiated by the server computer system 804. In other embodiments, however, the resource server 802 may proactively send the location-specific resource data 810 to server computer system 804 at a predetermined interval (e.g. once per day, once per hour, etc.). In some embodiments, it may be desirable for resource server 802 to provide updated resource data 810 to the server computer system 804 at periodic intervals so that, in the event that network connectivity between the resource server 802 and the server computer system 804 is interrupted during the course of an emergency event, server computer system 804 will still have a local copy of resource data 810 that is relatively up-to-date.

In various embodiments, the map-centric interface 902 is operable to display the location and status of one or more of the resources in the geographic area. For example, in some embodiments, the map-centric interface 902 includes a graphical map 904 that depicts icons 906 for the resources at their respective locations on the map 904. As a non-limiting example, map 904 of FIG. 9A includes icons 906 for various resources, including an icon 906A for a fuel truck, an icon 906B indicating the location of a police officer, an icon 906C indicating the location of a car accident, and an icon 906D indicating the location of a fire department personnel. In some embodiments, each type of resource (e.g., police officer, emergency responder, utility lineman, fleet vehicles, etc.) may be assigned a role, and each role assigned a corresponding icon that may be displayed on the map-centric interface 902 and used to indicate the current location of the corresponding resource. In various embodiments, the icons depicted on map-centric interface 902 are selectable by the user to receive additional information about the status of the selected resource. For example, with reference to the embodiment of FIG. 9A, a user of map-centric interface 902 may select the icon 906B corresponding to the police officer and, in response to this selection, be presented with an interface (e.g., as a dialog box, label, or any other suitable GUI element) that provides additional information about the police officer, such as his or her name, badge number, role, associated city or organization, current location, current availability, etc. In the embodiments of FIGS. 9A-9B, each different type of resource depicted on map-centric interface 902 is represented by a corresponding icon. Note, however, that the icons depicted on map-centric interface 902 of FIGS. 9A-9B are provided merely as examples and are not intended to limit the scope of the present disclosure. Further note that, in some embodiments, the roles and icons may be customizable by the entity utilizing alert dissemination application 860 to provide the emergency notification service.

In various embodiments, the location of the users that have elected to receive emergency notifications via the alert dissemination application 860 (e.g., users with the emergency notification application 880 installed on their user devices 808) may be depicted (e.g., in real-time or near real-time) on the map-centric interface 902. In various embodiments, the map-centric interface 902 may be used to distribute location-specific messages 910 to all user devices 808 or digital signs 806 that are located within a selected geographic area. For example, as shown in FIG. 9A, a user (e.g., TDEM personnel located at the SOC) may select a particular geographic area 908 on the map 904 (e.g., by clicking and dragging a cursor or through any other suitable input method) and elect to send one or more location-specific messages 910 to all (or some selected subset of) user devices 808 or digital signs 806 that are located in that selected geographic area 908. For example, in some embodiments, the user may select a particular geographic area 908 on the map 904 and then further specify one or more classes or categories of users for which to send a location-specific message 910. As a non-limiting example, the user may select the particular geographic area 908 and then select (e.g., via one or more input elements on the dashboard 902) one or more categories of first responders (e.g., police officers and EMS crews) to send a message 910. Note that a user may select a particular geographic area 908 of interest using various suitable techniques. For example, as described above with reference to FIG. 4b, a user may select a particular geographic area 908 by selecting particular roads/streets/highways/etc. to bound a particular geographic area 908, pick a particular point on the map 904 and select all user devices 808 or digital signs 806 within a certain radius of that point, select the particular geographic area 908 by zip code, area code, GPS, or other suitable coordinate/location systems, etc.

Once the user has selected a particular geographic area, the alert dissemination application 860 may identify one or more mobile devices 808 that have elected to receive emergency notification messages and are currently located within that area 908. The alert dissemination application 860 may identify those mobile devices 808 that are located within the particular geographic area 908 using various techniques. For example, in some embodiments, the server computer system 804 or the resource server 802 may periodically retrieve location information from the user devices 808. For example, alert dissemination application 860 may periodically (e.g., once per day, once per hour, every 15 minutes, etc.) ping the user devices 808 to obtain information about their current location. In other embodiments, however, it may be the user devices 808 that periodically provide location information to the resource server 802 or the server computer system 804. In still other embodiments, the alert dissemination application 860 may identify the user devices 808 that are within the particular geographic area based on the users' residences. For example, in some embodiments, during the process of registering to use the emergency notification service provided by the alert dissemination application 860, the users of devices 808 may establish user accounts, optionally providing certain items of personal information, such as residence address, neighborhood, city, etc. In some embodiments, after receiving the selection of the particular geographic area, the alert dissemination application 860 or resource server may then ping those user devices 808 in which the specified residence is within (or is within some predetermined distance of) the selected geographic area 908 to determine their current locations. Regardless of the manner in which the alert dissemination application 860 obtains the location information, once it has received the selection of the particular geographic area 908, the application 860 may identify those user devices 808 that are currently located within the area 908 based on this location information, according to various embodiments. In some embodiments, in addition to identifying those user devices 808 that are currently located within the selected geographic area 908, alert dissemination application 860 may also identify one or more users that are not currently in the selected area 908 but, based on past behavior, are deemed likely to travel into the selected area 908 while the emergency event in question is ongoing. For example, in some embodiments, alert dissemination application 860 is operable to analyze location information associated with one or more of the user devices 808 (e.g., using any suitable combination of one or more machine learning algorithms) to predict the likelihood that a given user will travel into the emergency area and preemptively send the user device 808 a location-specific emergency message 910. Further note that, in some embodiments, the disclosed systems and methods may utilize machine learning to aid in the vetting of reported resource information (e.g., from one or more reporting sources 812 of FIG. 8A).

Additionally note that, in some embodiments, once the alert dissemination application 860 has received a selection of the particular geographic area 908, it (or the resource server 802) may verify the location-specific resource data contained in the resource data store 856 prior to sending the location-specific messages to the user devices 808 or the digital signs 806. For example, once the alert dissemination application 860 receives the selection of the relevant geographic area 908, it may verify that the location-specific resource data for that area 908 is up-to-date within some predetermined time interval (e.g., it has been updated within the last hour, half-hour, etc.). If one or more items of location-specific data for that area have not been updated within that predetermined time interval (e.g., as indicated by metadata associated with the data, stored in resource data store 856), then the alert dissemination application 860 or the resource server 802 may send a request to one or more corresponding reporting sources 812 requesting that they update the resource data in question.

In various embodiments, the map-centric interface 902 is further operable to receive an indication of the location-specific message 910 to provide to the user devices 808 or digital signs 806. For example, as described above with reference to FIGS. 5A-5K, the map-centric interface 902 may provide various templates to assist the user in creating the location-specific message 910. In some embodiments, the map-centric interface 902 may provide various input elements (e.g., drop down menus, fill in boxes, radio buttons, text boxes, image upload elements, etc.) that the user may use to specify the location-specific message. In various embodiments, the location-specific message may include text, images, video, audio, or information in any other suitable format. For example, in various embodiments, the location-specific message 910 may include data that is usable by the user devices 808 to populate an interactive map such that it depicts the status of various resources within the particular geographic area 908. Some such embodiments are described in more detail below with reference to FIGS. 10A-10B.

Once it has obtained an indication of the location-specific message 910 and has identified the relevant user devices 808 or digital signs 806, the alert dissemination application 860 may send the location-specific messages 910 to the various user devices 808 or digital signs 806 that are currently located in the selected geographic area 908. As described above, in some embodiments, the location-specific message 910 may be sent directly from the alert dissemination application 860 to the one or more digital signs 806. In other embodiments, however, the alert dissemination application 860 may send the location-specific message 910 to one or more of the digital signs 806 via a third-party digital sign control system. Further, in various embodiments, the alert dissemination application 860 may send the location-specific message 910 to the user devices 808 using various techniques. For example, in some embodiments, the location-specific message 910 may be sent as a “push notification” via the emergency notification application 880 on the user device 808. In some such embodiments, this will cause an indication of the location-specific message 910 to be sent directly to the display of the user device 808 (e.g., as a banner notification, etc.), allowing the user to view more details regarding the location-specific message 910 via their emergency notification application 880. Note, however, that this embodiment is provided merely as an example and is not intended to limit the scope of the present disclosure. In other embodiments, for example, the location-specific message 910 may be sent to one or more of the user devices 808 in any other suitable format, such as an SMS message, an email, phone call, etc.

Turning now to FIG. 9B, a block diagram 950 depicts an alternate view of the map-centric interface 902, according to some embodiments. As in FIG. 9A, in various embodiments, map-centric interface 902 may be provided by alert dissemination application 860 and used to disseminate location-specific messages 910 to various user devices 808 or digital signs 806.

In FIG. 9B, map-centric interface 902 includes a toolbar 952 that may be used to selectively overlay graphical elements on interactive map 954. For example, toolbar 952 includes toggle switches 960 for various resources. In various embodiments, the user may use the switches 960 as filters to overlay data corresponding to a given category of resources on the map 954. In the depicted embodiment, for example, switches 960A, 960B, and 960C have been set by the user, thereby causing icons 962 corresponding to the respective resources to be displayed on the map 954. In some embodiments, each of the icons 962 may be selectable by the user such that, once selected, additional information is presented (e.g., via an additional window) via the map-centric interface 902 that includes additional information regarding the availability and status of the corresponding resource. As one non-limiting example, the user may select icon 962C and be presented with a pop-up window that provides additional information regarding the status (e.g. open or closed) and availability (e.g. two-thirds full, one-third full, etc.) of the corresponding gas station. In some embodiments, the status of a given resource (e.g., the amount of fuel at a gas station) may be represented using an icon. As one non-limiting example, the gas station corresponding to icon 962C may report information indicating the amount of fuel available, as discussed above. Once the operator selects the icon 962C, map-centric interface may present a separate icon indicative of the amount of fuel available at that location. In one embodiment, this information could be represented by a color-coded icon that signifies the status of the gas station and the amount of fuel available. For example, a red indicator may signify little or no available fuel, a yellow indicator may signify a limited amount of available fuel, a green indicator may signify a significant amount of available fuel, a gray indicator may signify that the gas station has not reported its status within a predetermined amount of time, and a black indicator may signify that the gas station is closed due to business hours. In some embodiments, the presence of such a gray-colored indicator may allow the operator to infer that the selected location is without electrical power or data access. Similar color-coded icons could be used to quickly relate the availability of any of the various resources depicted via map-centric interface 902, such as lodgings 960A, hardware stores 960B, grocery stores 960D, clinics 960E, shelters 960F, etc. In the depicted embodiment, toolbar 952 further includes toggle switches 964 and 966, which may respectively be used to display all establishments or only currently open establishments within the geographic area on the map 954.

Note that the toggle switches 960, 964, and 966 shown in FIG. 9B are provided merely as non-limiting examples. In other embodiments, map-centric interface 902 may be used to present any suitable category (or combination of categories) of resources on the map-centric interface 902. Other non-limiting examples of categories of resources that may be displayed on the map-centric interface 902 include: amount of rain or flooding, location of fires, location of mudslides, live weather radar, location and status of emergency shelters, traffic camera feeds, hospital locations and statuses, etc. In various embodiments, the user of alert dissemination application 860 may use these toggle switches to filter the types of resources that are displayed on the map-centric interface 902, as desired. Additionally, note that in some embodiments, map-centric interface 902 may provide icons that are indicative of a supply of a selected resource within a given area. For example, in some embodiments, when a user sets the toggle 960C for gas stations, map-centric interface 902 may depict the location of each of the gas stations in the selected area on the map 954. Further, as discussed above, icons corresponding to each of the gas stations (such as the color-coded icons discussed above) may be used to indicate the status or availability of the resource (gasoline, in the present example) at that particular location. In addition to these individual icons, in some embodiments, map-centric interface 902 may present an icon that indicates the aggregate availability of a particular resource over a particular geographic area. As one example, such an aggregate icon could be used to signify the availability of gasoline within the entire area (or some selected subset of the entire area) depicted in map 954.

Toolbar 952 further includes panel 968, which in various embodiments is operable to selectively display one or more outstanding distress calls. For example, as shown in FIG. 9B, six outstanding incidents 970 are depicted in panel 968. In various embodiments, the incidents 970 depicted via panel 968 may be selectable by a user such that, once selected, additional information about the incident 970 is provided to the user. In some embodiments, upon selecting a given incident 970, a location of the incident may be depicted on map 954, as shown in FIG. 9B. Further, in some embodiments, selecting an incident 970 may cause an additional window to be presented via map-centric interface 902 that includes additional information regarding the incident 970. In various embodiments, the ability to selectively display additional information regarding an incident 970 may facilitate the user's ability to properly monitor and allocate emergency resources to address distress calls in order of urgency and availability. For example, in various embodiments, the user of the alert dissemination application 860 may be in communication with one or more emergency services personnel, such as police officers, fire department personnel, EMS crews, etc. In various embodiments, the user (e.g., a government operator) of alert dissemination application 860 may use the map-centric interface 902 to direct one or more of the emergency services personnel to address various incidents 970. With reference to the embodiment depicted in FIG. 9B, for example, the user may send an emergency message to the emergency notification application 880 of a nearby police officer, instructing the police officer to address the incident 970A. In various embodiments, such notifications may be provided, for example, as push notifications on a user device of the emergency services personnel or their vehicle, via a text message, via a radio message, or in any other suitable format.

Toolbar 952 further includes buttons 972, which in various embodiments are operable to overlay information corresponding to evacuation routes, hazard zones, and distress calls, respectively. Note, however, that buttons 972 are provided merely as examples and are not intended to limit the scope of the present disclosure. In other embodiments, for example, additional buttons 972 may be provided such that other resource information may be overlaid on map 954. In the depicted embodiment, each of the buttons 972A, 972B, and 972C have been selected by the user, causing the corresponding information to be overlaid on map 954. For example, as shown in FIG. 9B, by selecting button 972A, various evacuation routes 974 are depicted on map 954. Similarly, by selecting button 972B, various hazard zones 976 have been identified on the map 954. Further, button 972C has been selected, causing panel 968 and content corresponding to the incidents 970 to be depicted on the map 954, as discussed above. Note that, in various embodiments, alert dissemination application 860 may use information retrieved from one or more third-party services to generate map-centric interface 902. As non-limiting examples, alert dissemination application 860 may retrieve information to facilitate the display of map-centric interface 902 from one or more map services, such as Esri, Google Maps, Mapbox, OpenLayers, etc., to generate an underlying map and overlay location-specific resource data 810 over the map-centric interface 902.

As mentioned above, in some embodiments, various user groups may use alert dissemination application 860 to send location-specific emergency notifications to user device 808 and digital signs 806. Non-limiting examples of such user groups include governmental entities associated with a geographic jurisdiction, such as cities, counties, municipalities, states, etc. Further, in various embodiment, user groups could include individual agencies within one or more of these entities, such as police departments, fire departments, emergency medical services, etc. Additionally, in some embodiments, user groups that may use alert dissemination application 860 may include private organizations, such as emergency notification organizations, hospitals, businesses, etc. In various embodiments, each of these various user groups may have one or more associated user accounts with which they may access the alert dissemination application 860. In various embodiments, one or more aspects of the alert dissemination application 860 may change based on the identity of the user group that is accessing it. For example, in some embodiments, the dashboard 902 will depict the areas that a given entity is licensed to use. For instance, when a user associated with a particular county logs in to access the alert dissemination application 860, the user may be presented with a map-centric interface 902 that depicts the particular county that the user is permitted to access.

In some instances, the alert dissemination application 860 may have at least four categories of users: resource participants, governmental entities, business entities, and public users. In some embodiments, resource participants (such as gas stations, grocery stores, hardware stores, hotels, department stores, temporary shelters, restaurants, etc.) may report their status (e.g., operating status) and the availability of their resources to the resource server 802 or server computer system 804. For example, resource participants may report their status and availability using an emergency notification application 880 executed on a user device 808 of an employee or owner of the resource participant or a computer system at the resource participant location, as described in more detail below with reference to FIGS. 10A-10C. As discussed above, in various embodiments governmental agencies may utilize the alert dissemination application 860 to manage and send emergency notifications regarding the location, status, and availability of resources in a particular area for which the government agency is authorized to perform such operations. Non-limiting examples of government agencies that may use the alert dissemination application 860 include: cities, counties, states, agencies, school districts, disaster districts, or any other suitable government entity. In various embodiments, the dashboard 902 of a governmental entity may include numerous components, such as: map points that are retrieved from in-store devices, aggregated statistics of resources by status, lists of last updated sites, live weather radar and shelter maps, live video streams of traffic cameras from various locations, individual resource details, charts of resource statuses, etc. For example, in some embodiments, the dashboard 902 may depict an amount of fuel remaining within a selected geographic area of the map-centric interface 902 and display (in real-time or near real-time) the remaining supply in an icon on the interface 902. In such embodiments, this may enable the governmental agency (or other type of user) operating the alert dissemination application 860 to divert people from gas stations at which there is no or insufficient amounts of fuel. Business entities, in various embodiments, may also opt to use the alert dissemination application 860 to monitor or locate various employees or resources. In some embodiments, this monitoring may be performed via dashboards 902 that collect on-site reporting from in-store devices, as described below with reference to FIG. 10C. Non-limiting examples of business entities that may use the alert dissemination application 860 to monitor or locate employees or resources include: companies that manage and perform installations (e.g., cable, phone, etc.), companies that manage trouble tickets in the field (such as linemen or city maintenance workers), field workers for various industries, or any other suitable business that desires real-time data on the location or status of their employees or resources. In various embodiments, these business entities can use the alert dissemination application 860 and dashboard 902 to oversee one or more branches or locations of their business, allowing the entity to see live updates of their sites, fleet vehicles, etc. Note that, in some embodiments, business entities may also be resource participants in the emergency notification service, described above. Additionally, as described in more detail below with reference to FIGS. 10A-10C, public users may elect to receive emergency notification messages from the alert dissemination application 860. In various embodiments, such public users may install the emergency notification application 880 on their user device 808, enabling the public users to receive location-specific emergency notifications and to report back (e.g., to the resource server 802 or the server computer system 804) the status of an emergency event or availability of a resource in a particular area. For example, such users may use their emergency notification application 880 to track radar updates, traffic conditions, or hazardous conditions based on the current location of the user device 808.

Additionally, note that in some embodiments the user of map-centric interface 902 may have the ability to change the status of one or more resources or areas on the map 954. For example, in some embodiments, the user may have the ability to designate a particular geographic area on the map 954 to a “closed” status via the map-centric interface 902, e.g., based on a lack of communication from the users in that area. In some instances, a user group (e.g., a police unit) will have an individual in the field that is in charge of managing one or more other individuals. In some instances, however, this person in charge may lose communication with the operator of the map-centric interface 902 (for example, as indicated by a lack of a “heartbeat” message from the user device 808 of the individual). In some such embodiments, the operator of the map-centric interface 902 is able to designate a different individual as being temporarily responsible for the management of one or more other individuals that are deployed in an emergency event. Further, in some embodiments, the alert dissemination application 860 may be used to assess the preparedness of particular areas (e.g., based on the availability of certain resources within those areas) prior to an emergency event, such as a hurricane. For example, the alert dissemination application 860 may be used to generate scores for different areas prior to an emergency event and generate information regarding the extent of the damage relative to the preparedness of the area. In some instances, the alert dissemination application 860 may track the extent to which the emergency notification messages sent via the application 860 mitigated the negative effects of an emergency event.

Referring now to FIG. 10A, block diagram 1000 depicts a user device 808 and emergency notification application 880, according to various embodiments. As noted above, in various embodiments, user device 808 and emergency notification application 880 are operable to receive and display location-specific messages 910 provided by the alert dissemination application 860.

In the depicted embodiment, emergency notification application 880 is operable to provide location information to a computer system (e.g., server computer system 804 or resource server 802) that is associated with the alert dissemination application 860. In some embodiments, for example, the user device 808 may provide this location information by sending periodic updates to the server computer system 804 at predetermined intervals (e.g. once per week, once per day, once per hour, etc.). In other embodiments, the user device 808 may provide the location information 1004 in response to a request from the alert dissemination application 860. For example, in some embodiments, the alert dissemination application 860 may ping user device 808 when preparing to send out one or more location-specific messages 910. In some such embodiments, the alert dissemination application 860 may request the location information 1004 from various user devices 808, as discussed above. In various embodiments, location information 1004 may be determined, for example, via a GPS unit included in the user device 808 and may indicate a current (or a recent) location of the user device 808.

As shown in FIG. 10A, user device 808 may receive one or more location-specific messages 910 from the alert dissemination application 860. As noted above, the content of the location-specific messages 910 may vary depending, for example, on the nature of the emergency events, the user device 808 to which the message 910 is sent, the role of the user associated with the user device 808 (e.g., emergency personnel, business owner or employee, citizen, etc.), the preferences of the operator at the server computer system 804, etc. As described in more detail below with reference to FIG. 10B, according to various embodiments, the location-specific message 910 may include data that is indicative of a current status of one or more resources in a particular geographic area in which the user device 808 is currently located. As shown in FIG. 10A, emergency notification application 880 provides a map-centric interface 1002 with an interactive map 1006 that is operable to display a current status of one or more resources in various geographic areas. In various embodiments, the map-centric interface 1002 may use the data in message 910 to populate the interactive map 1006 with information indicative of the current status of one or more of these resources in a given geographic area. Note that, in some embodiments, emergency notification application 880 may also retrieve information from one or more other services to facilitate the display of interactive map 1006. As non-limiting examples, in some embodiments the emergency notification application 880 may retrieve information to facilitate the display of interactive map 1006 from one or more map services, such as Esri, Google Maps, Mapbox, OpenLayers, etc., and overlay location-specific resource information from message 910 on the interactive map 1006.

Note that, in various embodiments, user devices 808 and digital signs 806 may communicate with resource server 802 or server computer system 804 using any of various suitable communication protocols or technologies. For example, user devices 808 and digital signs 806 may be configured to communicate using one or more cellular communication technologies (e.g., GSM, LTE, 4G, etc.) or via satellite network communication. Further, in some embodiments, user devices 808 and digital signs 806 may be configured to communicate using one or more other wireless networking protocols (e.g., Wi-Fi), a peer-to-peer wireless communication protocol (e.g., Bluetooth, NFC, etc.) text messaging services (e.g., SMS, etc.) or any other suitable communication protocol or technology, as desired.

Turning now to FIG. 10B, diagram 1020 depicts an example map-centric interface 1002 displaying location-specific resource information, according to some embodiments. As noted above with reference to FIG. 10A, map-centric interface 1002 may be used to view information indicative of a current status of one or more resources (e.g. gas, food, water, etc.) in various geographic areas, including the location in which the user device 808A is currently located.

In FIG. 10B, map-centric interface 1002 includes a toolbar 1022 that may be used to selectively overlay graphical elements on interactive map 1006. For example, toolbar 1022 includes toggle switches 1024A-1024F corresponding to various categories of resources. In various embodiments, the user of device 808A may use the switches 1024 as filters to selectively overlay data corresponding to given categories of resources on the interactive map 1006. In the depicted embodiment, for example, only switch 1024C has been set by the user, thereby causing icon 1028C indicating the location of a gas station to be displayed on the interactive map 1006. As noted above with reference to FIG. 9B, icon 1028C may be selectable by the user such that, once selected, an additional window is presented (e.g., via the map-centric interface 1002 or in a separate interface of the emergency notification application 880) that includes additional information regarding the availability and status of the resource. For example, if the user of user device 808A were to select the icon 1028C, she would be presented with an interface (e.g., a pop-up window) that provides additional information regarding the status (e.g., open or closed) and availability (e.g., two-thirds full, one-third full, etc.) of the corresponding gas station. Toolbar 1022 further includes toggle switches 1026A and 1026B, which may respectively be used to display all establishments or only currently open establishments in the relevant geographic area via the interactive map 1006. Note that the categories of resources corresponding to toggle switches 1024 in FIG. 10B are provided merely as an example and are not intended to limit the scope of the present disclosure. In other embodiments, any suitable combination of categories of resources may be presented via the map-centric interface 1002. Additionally, note that the embodiment of map-centric interface 1002 depicted in FIG. 10B is provided merely as an example and is not intended to limit the scope of the present disclosure. In some embodiments, the one or more aspects of the emergency notification application 880 or map-centric interface 1002 (including its appearance or available features) may vary between different user groups and between different users within user groups. For example, the appearance and functionality of emergency notification application 880 may be different for a police officer than for the same application 880 utilized by a resource provider (e.g., a hospital employee).

Further, as shown in FIG. 10B, map-centric interface 1002 is also operable to display the location and status of nearby emergency personnel and fuel trucks, according to some embodiments. For example, as shown in FIG. 10B, map 1006 depicts an icon 1030 corresponding to a fire department crew. In various embodiments, icon 1030 is selectable by the user of user device 808A such that, once selected, the user may be presented with additional information about the fire department crew, such as its current status, destination, etc. Additionally, as shown in FIG. 10B, map-centric interface 1002 includes buttons 1032A-1032C. Similar to buttons 972 of FIG. 9B, buttons 1032, in various embodiments, are operable to overlay information corresponding to evacuation routes, optimal routes to avoid traffic or roadwork, hazard zones, and distress calls on interactive map 1006. Note, however, that buttons 1032 are provided merely as examples and are not intended to limit the scope of the present disclosure. In other embodiments, for example, additional buttons 1032 may be provided such that other resource information may be overlaid on map 1006.

Note that, in some embodiments, map-centric interface 1002 provided by emergency notification application 880 may also be used to provide strategic routing information to the user to aid the user in responding to an emergency event. For example, the user may utilize the emergency notification application 880 in a state of emergency to map out his or her routes based on evacuation routes published by one or more governmental agencies.

Further note that, although described with reference to user device 808A, in various embodiments, some aspects of map-centric interface 1002 and map 1006 may also be used as content depicted on one or more digital signs 806. For example, in some embodiments, the alert dissemination application 860 may cause a map similar to map 1006 depicted in FIG. 10B to be displayed on one or more digital signs in a given geographic area (e.g. the selected geographic area 908 of FIG. 9A). In some such embodiments, the alert dissemination application 860 may cause a map to be depicted on one or more digital signs 806, with the map populated with information indicative of a current status of one or more resources in an area in which the digital signs 806 are located. For example, when sending content to a digital sign 806 that is a roadway billboard, the alert dissemination application 860 may send data indicative of a map that indicates a current status of one or more resources in the area in which the roadway billboard is located. Further note, that in some embodiments, one or more digital signs 806 may be operable to display an interactive map (similar to interactive map 1006) populated with information indicative of a current status of one or more resources in the location in which the digital signs 806 are located. For example, in some embodiments, a digital sign 806 may be an informational kiosk located at an office park, shopping mall, sidewalk, etc. In such embodiments, individuals may use the interactive map provided via the digital sign 806 to selectively view various sets of information indicative of a current status of one or more resources, as described above with reference to FIG. 10B.

In FIG. 10C, diagram 1040 depicts an example reporting form user interface (“UI”) 1042, according to some embodiments. In various embodiments, reporting form UI 1042 may be provided by emergency notification application 880 and used by reporting sources 812 to report information, such as the status of one or more resources or of an emergency event, to resource server 802 or server computer system 804 of FIGS. 8A-8B. As noted above with reference to FIG. 8A, various individuals (such as citizens 814, police 816, fire department personnel 818, EMS crews 820, DOT personnel 824, etc.) and merchants (e.g., providers of food 826, shelter 828, fuel 830, etc.) may use reporting form UI 1042 to provide updated status information to the resource server 802 or the server computer system 804. For example, emergency responders (e.g., police officers, firefighters, EMS crews, etc.) may use the emergency notification application 880 to report their location such that they may be efficiently deployed to the necessary locations. In some embodiments, emergency notification application 880 enables such users to “turn on” a feature that shares their location information with the resource server 802 or the server computer system 804. Once such a location feature is activated, in various embodiments, icons corresponding to the location of these users may be depicted on the map-centric interface 902 (e.g., used by one or more operators to monitor and manage resources) or the map-centric interface 1002. Similarly, this location information feature may be used by other types of users, such as employees of business entities to provide their location information to their employer through the map-centric interface 902. In some embodiments, such as the embodiment depicted in FIG. 10C, reporting form UI 1042 may be included as part of the functionality provided by emergency notification application 880. In other embodiments, reporting form UI 1042 may be provided as part of a web-based platform provided by resource server 802 or alert dissemination application 860.

Reporting form UI 1042 may include any of various suitable input fields. For example, in the depicted embodiment, reporting form UI 1042 includes button 1044, that may be used to initiate the reporting process, contact name field 1046, which may be used to specify the identity of the reporting party, business name field 1048, which may be used to identify the provider (if any) of the resource being reported, location field 1050, which may be used to specify the location of the resource being reported. Note that, in some embodiments, reporting form UI 1042 may allow the user to simply select a “use current location” option in which location information for the user device 808A will be populated into the location field 1050. Thus, in various embodiments, the user devices 808 located at the resource or emergency sites may proactively provide their location information to the resource server 802 or server computer system 804. Reporting form UI 1042 further includes checkboxes 1052, which may be used to specify the type of business (if any) that provides the resource being reported, radio buttons 1054, which may be used to specify the status of the resource (e.g., open or closed, in the depicted embodiment). Additionally, in the depicted embodiment, reporting form UI 1042 includes contact phone number field 1056, which may be used to specify a phone number for the reporting party (if desired), contact email field 1058, which may be used to specify an email address for the reporting party (if desired), and a message field 1060, may be used to specify a text-based message to include with the report message 1080. Note, however, that the input elements shown in FIG. 10C are provided merely as one non-limiting example. In other embodiments, any various combination of input elements may be provided by reporting form UI 1042. Further note that, in various embodiments, one or more of the fields shown in reporting form UI 1042 may be automatically populated for a given user with account information stored by the emergency notification application 880. For example, the user of user device 808A may establish a user account with the entity (e.g., governmental entity or private organization) that provides the emergency notification service via the alert dissemination application 860. In such embodiments, some or all of the account information associated with the user's account may be stored on the user device 808A, which the emergency notification application 880 may then use to auto-populate one or more fields of the reporting form UI 1042, such as the contact name field 1046, business name field 1048, type of business checkbox 1052, contact phone number field 1056, contact email field 1058, etc.

In the depicted embodiment, reporting form UI 1042 further includes a submit button 1062. In various embodiments, upon selecting the submit button 1062, the emergency notification application 880A is operable to send a report message, specifying the information provided in the various input elements, to server computer system 804 or resource server 802 of FIGS. 8A-8B. In various embodiments, the information included in this report message may subsequently be provided in one or more notification messages received from the alert dissemination application 860, according to some embodiments. That is, in some embodiments, the information reported via reporting form UI 1042 may be included in the map-centric interface 1002 provided to one or more user devices 808 or digital signs 806. For example, if a user of device 808A reports information about a car accident to the resource server 802, the alert dissemination application 860 may send out one or more updated location-specific messages that reflect this new information. In some such embodiments, the updated location-specific messages would include data usable by the mobile devices 808 or digital signs 806 to populated a map that indicates this newly reported car accident in its respective location on a map (such as interactive map 1006 of FIG. 10B). Further note that, in some embodiments, reporting form UI 1042 may allow the user of device 808A to provide other information in the report message, such as one or more photos, videos, or audio recordings. Continuing with the example above, for instance, the user of device 808A may provide, in addition to various items of information, a picture of the scene surrounding the car accident. In another non-limiting example, the user of user device 808A may be an employee at a business (e.g., a restaurant, gas station, grocery store, etc.) and may submit information indicative of the status of the business and the availability of the resources it provides. For example, an employee associated with a hotel may specify the number of rooms available, a gas station employee may specify the number of gallons of fuel available, a grocery store employee may specify the amount of water available, etc. To do so, the user can fill out the reporting form UI 1042 as discussed above to specify the status and availability of the resources of the business. The employee may also include a photo or video of the business to submit along with the information in the reporting form UI 1042. The information provided by the user may then be sent from the user device 808A to the alert dissemination application 860, where it may be viewed on the map-centric interface 902 described above. In some embodiments, the information provided by the user devices 808 may be used to populate one or more icons displayed via the map-centric interface 902. For example, as discussed above, in some embodiments a resource provider (e.g., gas station) may be depicted on the map-centric interface 902 as a color-coded icon in which the color of the icon corresponds to the status of the resource provider or the availability of its resources. For example, in some embodiments, a green icon may indicate that the resource provider is open and operating at normal conditions, a yellow icon may indicate that the resource provider is operating with limited resources, a red icon may indicate that the resource provider has little to no available resources, a black icon may indicate that the resource provider is closed due to operating hours, and a gray icon may indicate that the resource provider has been out of communication for some predetermined amount of time (e.g., an hour). If the status of a resource provider is limited or closed (denoted, for example, by a yellow or red icon, respectively) reporting resource providers may be prompted to provide additional information about the limited or closed status. For example, in some embodiments, the user of the resource provider may be presented with a list of reasons explaining the limited or closed status. Non-limiting examples of such reasons may include: no data service available, no water, no electrical power, looters, power line(s) down, flooding, etc. These reasons may be indicated, for example, by check boxes or input textboxes in the reporting form UI 1042.

In various embodiments, the map-centric interface 902 may automatically refresh (e.g., after a particular interval, such as every 15 seconds) or operate in a push/pull manner in which the interface 902 is manually refreshed to retrieve new location-specific information. In some embodiments, the information provided by users in various locations (such as the picture provided by the user at the location of the car accident or the employee at the business) may be provided by the alert dissemination application 860 as part of the location-specific message provided to the various user devices 808 or digital signs 806. For example, in some embodiments, the map-centric interface 1002 may include a selectable icon on the interactive map 1006 that corresponds to the newly reported car accident. In some embodiments, the user of the alert dissemination application 860 may be alerted of this status update from the user device 808 via a push notification, as one non-limiting example. In some such embodiments, the user may select this icon to view additional information about the reported incident, including the picture taken by the reporting user. Further note that, in some embodiments, emergency notification application 880 is operable to perform various other functions to assist the user in responding to an emergency event. As a non-limiting example, in some embodiments, emergency notification application 880 is operable to enable a user to book a room at a nearby hotel.

Additionally, note that user device 808 (such as user device 808A of FIGS. 10A-10C) may be any of various suitable computing devices. For example, in some embodiments, user device 808 may be a mobile computing device, such as a smartphone, tablet computer, laptop computer, etc. In other embodiments, user device 808 may be a non-mobile computing device such as a desktop computer or workstation terminal (e.g., located at a resource provider's business). Further, in various embodiments, user device 808 may belong to a public user (e.g., a civilian in the area of an emergency event) or a resource provider or business entity (e.g., a gas station, restaurant, grocery store, etc.). In various embodiments, user device 808 is configured to execute the emergency notification application 880 to report the location, status, or availability of resources to resource server 802 or server computer system 804, regardless of the type of the user device 808 or the identity of the user.

Note that the functionality of emergency notification application 880 described with reference to FIGS. 10A-10C is provided merely as a non-limiting example. In some embodiments, multiple versions of the emergency notification application 880 may be provided (e.g., via an application store) where the functionality of emergency notification application 880 may vary between versions. For example, in some embodiments, different versions of emergency notification application 880 may be designed for different types or categories of users. As a non-limiting example, in some embodiments, one or more versions of the emergency notification application 880 may be designed for emergency personnel (e.g., police officers, firefighters, EMS crew, etc.). In such embodiments, the emergency notification application 880 may provide functionality specific to emergency personnel, such as the ability to respond to emergency dispatch instructions (as one non-limiting example). Similarly, in some embodiments, one or more versions of the application 880 may be designed specifically for civilian users, for business owners/employees, etc. Further, in various embodiments, one or more aspects of the functionality of emergency notification application 880 may vary based on a role of the user that is using the application 880. As one non-limiting example, in some instances, groups of users (e.g., emergency personnel, such as police officers) may be organized into a hierarchy. In such instances, it may be advantageous to provide some users (e.g., higher ranking police officers) with certain types of functionality that is not available to other users within that group. As one example, it may be desirable to enable a high-ranking police officer the ability to create custom notifications to be pushed to other officers in a selected geographic area. In some embodiments, the role of a user may be established based on user credentials provided by the user (e.g., during a login operation on the emergency notification application 880). For example, during a login operation, the user may be prompted to provide user credentials (e.g., a username, password, PIN number, biometric, etc.), which may then be routed to the alert dissemination application 860. In some such embodiments, the alert dissemination application 860 is operable to determine a role of the user based on the provided credentials and send, to the user device 808 of the user, information that may modify the functionality of emergency notification application 880. Further note that, in some embodiments, roles for given users (e.g., emergency personnel deployed in the field) may be dynamically assigned by one or more users of the alert dissemination application 860. For example, if a user that has been designated with a certain role has not responded to emergency messages from the alert dissemination application 860 within a predetermined time period (e.g., 30 minutes, 1 hour, 1 day, etc.), a user of the alert dissemination application 860 may dynamically assign that role to a different user, potentially enabling a greater (or simply different) range of functionality to be performed by the emergency notification application 880 of the user with the newly assigned role.

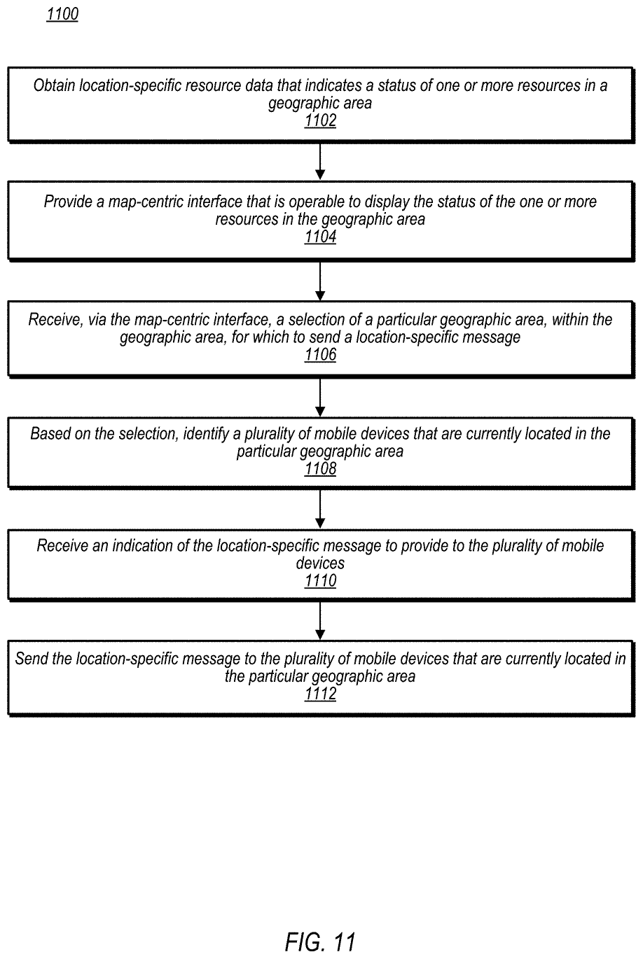

Referring now to FIG. 11, a flow diagram illustrating an example method 1100 for disseminating location-specific messages is depicted, according to some embodiments. In various embodiments, method 1100 may be performed by alert dissemination application 860 executed by server computer system 804 of FIGS. 8A-8B to disseminate location-specific emergency messages to various user devices 808 or digital signs 806. For example, server computer system 804 may include (or have access to) a non-transitory, computer-readable medium having program instructions stored thereon that are executable by the server computer system 804 to cause the operations described with reference to FIG. 11. In FIG. 11, method 1100 includes elements 1102-1112. While these elements are shown in a particular order for ease of understanding, other orders may be used. In various embodiments, some of the method elements may be performed concurrently, in a different order than shown, or may be omitted. Additional method elements may also be performed as desired.

At 1102, in the illustrated embodiment, the alert dissemination application obtains location-specific resource data that indicates the status of one or more resources in a geographic area. For example, as shown in FIG. 8B, the server computer system 804 may obtain location-specific resource data 810 from the resource server 802. As discussed in more detail above with reference to FIG. 8A, resource server 802, in turn, may obtain resource information from various ones of the reporting sources 812. In various embodiments, the alert dissemination application 860 may obtain this location-specific resource data 810 by retrieving it from a resource data store 856 maintained by resource server 802.

At 1104, in the illustrated embodiment, the alert dissemination application provides a map-centric interface that is operable to display the status of one or more resources in the geographic area. In some embodiments, the map-centric interface includes a graphical map that depicts icons for the one or more resources at respective locations on the graphical map. For example, with reference to FIG. 9A, the map-centric interface 902 may include an interactive map 904 that depicts icons 906 for various resources at their respective locations on the map 904. As one non-limiting example, in some embodiments the map-centric interface 902 may include video displays from one or more traffic cameras located in an area for which the operator is authorized monitor resources and send emergency notifications. In some such embodiments, map-centric interface 902 may enable the operator to select a desired area on the map to access a street view of the selected location, if available via one or more of the traffic cameras.

At 1106, in the illustrated embodiment, the alert dissemination application receives, via the map-centric interface, a selection of a particular geographic area for which to send a location-specific message. For example, as shown in FIG. 9A, an operator of the alert dissemination application 860 may use the map-centric interface 902 to make a selection of a particular geographic area 908 that is depicted on the map 904. In various embodiments, the user of alert dissemination application 860 may make various such selections to identify one or more geographic areas 908 for which to send location-specific messages 910.

At 1108, in the illustrated embodiment, the alert dissemination application identifies a plurality of mobile devices that are currently located in the particular geographic area based on the selection. The manner in which the alert dissemination application 860 identifies the mobile devices that are currently located in the particular geographic area may vary, according to various embodiments. For example, in some embodiments, the alert dissemination application 860 or the resource server 802 may periodically (e.g., once per day, once per hour, every 10 minutes, or at any other suitable time interval) retrieve location information from a set of mobile devices 808 that have elected to receive notifications from the emergency notification service provided via the alert dissemination application 860. For example, in some embodiments, in response to receiving the selection of the particular geographic area 908 via the map-centric interface 902, the alert dissemination application 860 may be operable to send a request to the plurality of mobile devices 808 for location information associated with each. Alternatively, in some embodiments, the alert dissemination application 860 may instead send a request to the resource server 802 for such location information. In such embodiments, the resource server 802 may then send the requests to the plurality of mobile devices 808 for this location information. In other embodiments, emergency notification applications 880 executing on the set of user devices 808 may be configured to proactively provide such location information to the resource server 802 or the server computer system 804. For example, in some embodiments, the emergency notification application 880 installed on the user devices 808 is operable to provide such location information at periodic intervals, such as once per day, every three hours, every 30 minutes, or at any other suitable time interval. Regardless of which entity initiates the transfer of this location information, however, in various embodiments the alert dissemination application 860 is operable to identify the plurality of mobile devices 808 by selecting the plurality of mobile devices from the set of devices based on this location information.

At 1110, in the depicted embodiment, the alert dissemination application receives an indication of the location-specific message to provide to the plurality of mobile devices. For example, as described above, in various embodiments the map-centric interface 902 may provide various templates to assist the user in creating a location-specific message 910. In some such embodiments, the map-centric interface 902 may provide various input elements that the user may use to specify the location-specific message 910. In various embodiments, the location-specific message 910 may include text, images, video, audio, or any other suitable information. For example, in some embodiments, the location-specific message 910 may include data that is usable by the user devices 808 or the digital sign 806 to populate a map such that it depicts the status of various resources within a particular geographic area, such as the geographic area in which the user devices 808 or digital signs 806 are located.

At 1112, in the depicted embodiment, the alert dissemination application sends the location-specific emergency message to the plurality of mobile devices that are currently located in the particular geographic area. In some embodiments, the location-specific message 910 may include a text-based notification corresponding to the status of one or more resources in the particular geographic area. For example, the alert dissemination application 860 may send a push notification to the plurality of user devices 808 such that the location-specific message 910 is presented on a display (e.g., as a banner notification or in any other suitable presentation format) of the respective user devices 808. Further, in some embodiments, the location-specific message may include message data that is usable by the plurality of mobile devices to populate an interactive map with information that is indicative of the status of at least one resource in the particular geographic area. In various such embodiments, this message data that is included in the location-specific message is usable by the plurality of mobile devices to overlay a current location of one or more emergency services onto the interactive map, for example as depicted in FIG. 10B. Additionally, in some embodiments, the message data included in the location-specific message 910 is usable by the plurality of mobile devices 808 to overlay one or more evacuation routes onto the interactive map.

In various embodiments, method 1100 further includes the alert dissemination application causing content corresponding to the location-specific message to be displayed on one or more digital signs that are located within the particular geographic area. In some such embodiments, the content includes a second graphical map that corresponds to the geographic area, where the second graphical map depicts icons indicative of the location and status of at least one resource within the particular geographic area. Additionally, in some embodiments, method 1100 further includes receiving, from a first mobile device, additional location-specific resource data that indicates an updated status of at least one resource in the geographic area. In some such embodiments, the alert dissemination application may then update the map-centric interface (e.g. map-centric interface 902 of FIG. 9A) to display the updated status of this resource on the graphical map (e.g. map 904).

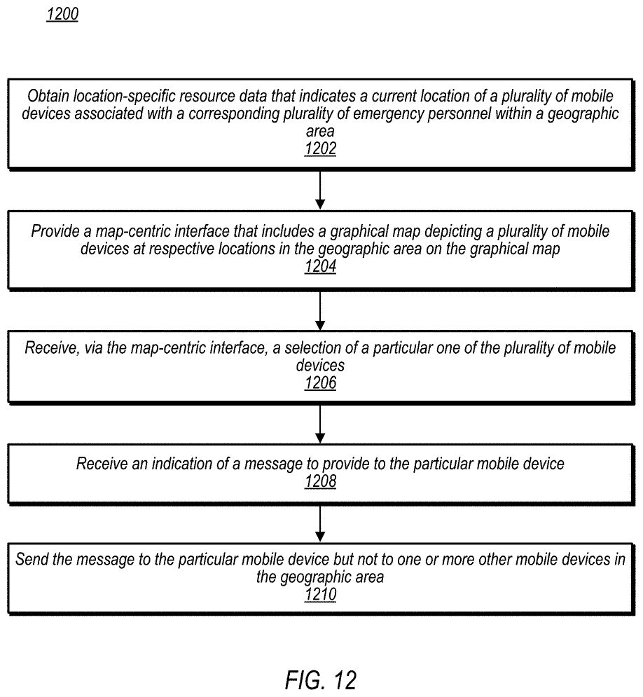

Turning now to FIG. 12, a flow diagram illustrating an example method 1200 for disseminating a location-specific message to a selected user device is depicted, according to some embodiments. In various embodiments, method 1200 may be performed by alert dissemination application 860 executed by server computer system 804 of FIGS. 8A-8B to disseminate a location-specific message 910 to a selected user devices 808, such as a device 808 associated with an emergency service provider (e.g., a police officer, EMS crew, fire department personnel, etc.). For example, server computer system 804 may include (or have access to) a non-transitory, computer-readable medium having program instructions stored thereon that are executable by the server computer system 804 to cause the operations described with reference to FIG. 12. In FIG. 12, method 1200 includes elements 1202-1210. While these elements are shown in a particular order for ease of understanding, other orders may be used. In various embodiments, some of the method elements may be performed concurrently, in a different order than shown, or may be omitted. Additional method elements may also be performed as desired.

At 1202, in the depicted embodiment, the alert dissemination application 860 obtains location-specific resource data that indicates a current location of a plurality of mobile devices associated with a corresponding plurality of emergency personnel within a geographic area. For example, in various embodiments, emergency services personnel may carry a mobile device that is operable to transmit location information to the resource server 802 or the server computer system 804. In some embodiments, for example, the mobile devices carried by the emergency services personnel may include an emergency notification application 880 that may be used both to receive emergency messages and to provide updates regarding the status and location of the emergency services.

At 1204, in the depicted embodiment, the alert dissemination application may provide a map-centric interface that includes a graphical map depicting the plurality of mobile devices at respective locations in the geographic area on the graphical map. For example, as shown in FIG. 9A, map 904 may be populated with one or more icons 906 indicating a location and status of the respective emergency services personnel. At 1206, in the illustrated embodiment, the alert dissemination application 860 receives, via the map-centric interface, a selection of a particular one of the plurality of mobile devices corresponding to the emergency services personnel. For example, in FIG. 9A, the alert dissemination application 860 may receive a selection of icon 906B corresponding to a police officer.

At 1208, in the depicted embodiment, the alert dissemination application receives an indication of the message to provide to the particular mobile device. For example, as discussed above, the map-centric interface may provide various input elements that may be used to specify a message to provide to the particular mobile device. In some embodiments, this message may include instructions for the respective emergency services personnel to address one or more emergency events. At 1210, in the depicted embodiment, the alert dissemination application 860 sends the message to the particular mobile device. As with the location-specific messages 910, the message sent at 1210 may include content in various suitable formats, such as a text-based message, images, video, audio, or data that is usable by the mobile device to populate an interactive map such that it depicts a location of the emergency event to which the emergency service personnel is to be dispatched.

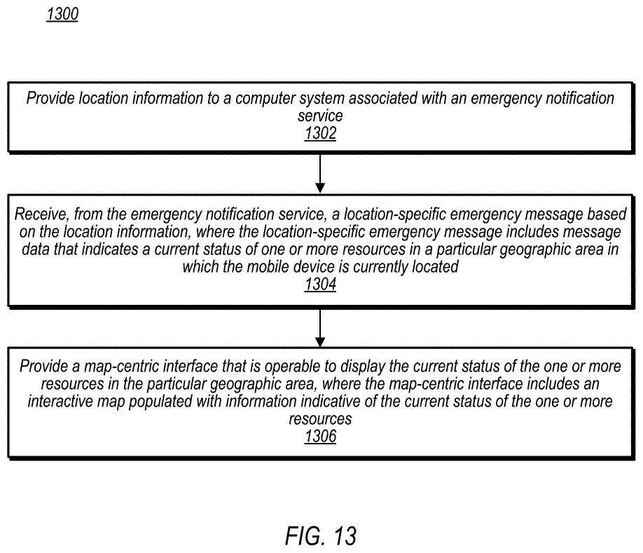

Turning now to FIG. 13, a flow diagram illustrating an example method 1300 for presenting a location-specific message via a map-centric interface is depicted, according to some embodiments. In various embodiments, method 1300 may be performed by emergency notification application 880A executed by user device 808A of FIG. 10A. For example, user device 808A may include (or have access to) a non-transitory, computer-readable medium having program instructions stored thereon that are executable by the user device 808A to cause the operations described with reference to FIG. 13. In FIG. 13, method 1300 includes elements 1302-1306. While these elements are shown in a particular order for ease of understanding, other orders may be used. In various embodiments, some of the method elements may be performed concurrently, in a different order than shown, or may be omitted. Additional method elements may also be performed as desired.

At 1302, in the illustrated embodiment, the mobile device provides location information to a computer system that is associated with an emergency notification service. For example, shown in FIG. 10A, emergency notification application 880A is operable to provide location information 1004 to a computer system associated with the emergency notification service provided by the alert dissemination application 860, such as the server computer system 804 or the resource server 802. In some embodiments, emergency notification application 880A is operable to periodically send updated location information to one or more of these computer systems associated with the emergency notification service. For example, in some embodiments, emergency notification application 880A is operable to provide updated location information every hour, every 15 minutes, every one minute, or at any other suitable time interval. Further, in some embodiments, emergency notification application 880A is operable to provide the updated location information in response to a change in its current location that is greater than some predetermined threshold. For example, in some such embodiments, emergency notification application 880A is operable to monitor its current location, e.g., via a GPS unit on the user device 808A. In response to the current location of the user device 808A changing by more than some predetermined threshold, the emergency notification application 880A may then send updated location information to one or more of the resource server 802 or the server computer system 804. As one non-limiting example, emergency notification application 880A may send updated location information in response to a determination that, since the last time that it provided location information, its current location is changed by more than 5 miles. Note, however, that this embodiments is provided merely as an example and is not intended to limit the scope of the present disclosure. In other embodiments, various suitable distance thresholds may be used.

At 1304, in the illustrated embodiment, the mobile device receives, from the emergency notification service, a location-specific message based on the location information sent in element 1302. In various embodiments, this location-specific message includes message data that indicates a current status of one or more resources in a particular geographic area in which the mobile devices currently located. For example, as shown in FIG. 10A, the user device 808A may receive a location-specific message 910 from the alert dissemination application 860

At 1306, in the depicted embodiment, the mobile device provides a map-centric interface that is operable to display the current status of the one or more resources in the particular geographic area. For example, as shown in FIG. 10B, emergency notification application 880A may provide map-centric interface 1002, which includes an interactive map 1006 populated with information indicative of the current status of the one or more resources. In some embodiments, the message data (included in the location-specific message 910) includes status information for a plurality of categories of resources, such as food, lodgings, fuel, etc. In various embodiments, the mobile device may receive, via the map-centric interface, a selection of a first one of a plurality of categories of resources. In response to the selection of this first category, the emergency notification application 880 may populate the interactive map with one or more icons depicting the current status of resources belonging to the first category at respective locations on the interactive map. For example, in FIG. 10B, the user may select the toggle switch 1024D, which may cause the interactive map 1006 to be populated with icons indicative of the current status of one or more grocery stores in the area of the user device 808A depicted on the interactive map 1006. Note that, in various embodiments, the map-centric interface is operable to overlay icons for resources belonging to various combinations of categories. For example, in some embodiments, the emergency notification application 880A may receive, via the map-centric interface 1002, a selection of a second one of the plurality of categories of resources, and based on that selection may further populate the interactive map 1006 with one or more icons depicting the current status of resources belonging to this second category at respective locations on the interactive map. Further note that information corresponding to one or more other, non-selected categories of resources may not be depicted via the interactive map 1006. For example, if the user has not selected the toggle switch 1024B, corresponding to hardware stores, then the emergency notification application 880A may not populate the interactive map 1006 with icons for that category of resources.

In some embodiments, method 1300 may further include sending, by the mobile device to the emergency notification service, a report message that indicates an updated status of at least one resource in the particular geographic area in which the user device 808A is located. After sending the report message, the mobile device may then receive second message data, from the emergency notification service, that includes the updated status of that at least one resource. In some such embodiments, method 1300 includes updating the map-centric interface 1002 to display the updated status of this resource on the interactive map 1006. Additionally, in some embodiments, the report message may include a picture taken by the mobile device within the particular geographic area. In some such embodiments the map-centric interface 1002 may be updated to depict a selectable icon for the picture at a respective location on the interactive map. Further note that, in some embodiments, users may be incentivized to use the emergency notification application 880. For example, in some embodiments, the user may be able to accumulate rewards points based on a number of miles traveled, by the user device 808, while using the emergency notification application 880.

### Example Computer System

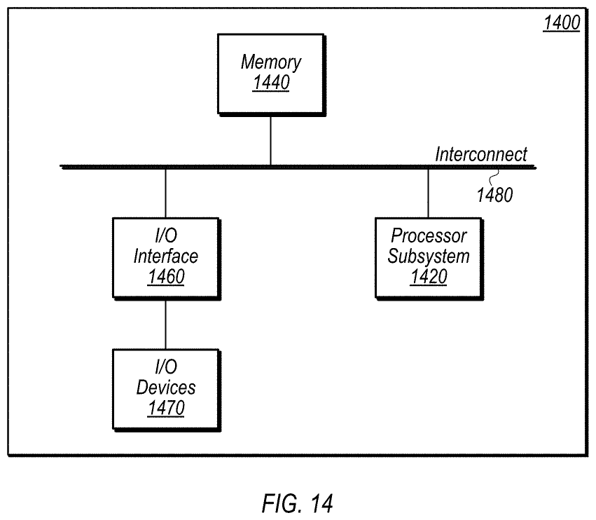

Referring now to FIG. 14, a block diagram of an example computer system 1400 is depicted, which may implement one or more computer systems, such as server computer system 804, resource server 802, user device 808, or digital sign 806, according to various embodiments. Computer system 1400 includes a processor subsystem 1420 that is coupled to a system memory 1440 and I/O interfaces(s) 1460 via an interconnect 1480 (e.g., a system bus). I/O interface(s) 1460 is coupled to one or more I/O devices 1470. Computer system 1400 may be any of various types of devices, including, but not limited to, a server computer system, personal computer system, desktop computer, laptop or notebook computer, mainframe computer system, server computer system operating in a datacenter facility, tablet computer, handheld computer, workstation, network computer, etc. Although a single computer system 1400 is shown in FIG. 14 for convenience, computer system 1400 may also be implemented as two or more computer systems operating together.

Processor subsystem 1420 may include one or more processors or processing units. In various embodiments of computer system 1400, multiple instances of processor subsystem 1420 may be coupled to interconnect 1480. In various embodiments, processor subsystem 1420 (or each processor unit within 1420) may contain a cache or other form of on-board memory.

System memory 1440 is usable to store program instructions executable by processor subsystem 1420 to cause system 1400 perform various operations described herein. System memory 1440 may be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 1400 is not limited to primary storage such as system memory 1440. Rather, computer system 1400 may also include other forms of storage such as cache memory in processor subsystem 1420 and secondary storage on I/O devices 1470 (e.g., a hard drive, storage array, etc.). In some embodiments, these other forms of storage may also store program instructions executable by processor subsystem 1420.

I/O interfaces 1460 may be any of various types of interfaces configured to couple to and communicate with other devices, according to various embodiments. In one embodiment, I/O interface 1460 is a bridge chip (e.g., Southbridge) from a front-side to one or more back-side buses. I/O interfaces 1460 may be coupled to one or more I/O devices 1470 via one or more corresponding buses or other interfaces. Examples of I/O devices 1470 include storage devices (hard drive, optical drive, removable flash drive, storage array, SAN, or their associated controller), network interface devices (e.g., to a local or wide-area network), or other devices (e.g., graphics, user interface devices, etc.). In one embodiment, I/O devices 1470 includes a network interface device (e.g., configured to communicate over WiFi, Bluetooth, Ethernet, etc.), and computer system 1400 is coupled to a network via the network interface device.

Although the embodiments disclosed herein are susceptible to various modifications and alternative forms, specific embodiments are shown by way of example in the figures and are described herein in detail. It should be understood, however, that figures and detailed description thereto are not intended to limit the scope of the claims to the particular forms disclosed. Instead, this application is intended to cover all modifications, equivalents and alternatives falling within the spirit and scope of the disclosure of the present application as defined by the appended claims. The headings used herein are for organizational purposes only and are not meant to be used to limit the scope of the description.

This disclosure includes references to “one embodiment,” “a particular embodiment,” “some embodiments,” “various embodiments,” “an embodiment,” etc. The appearances of these or similar phrases do not necessarily refer to the same embodiment. Particular features, structures, or characteristics may be combined in any suitable manner consistent with this disclosure.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. As used herein, the term “or” is used as an inclusive or and not as an exclusive or. For example, the phrase “at least one of x, y, or z” means any one of x, y, and z, as well as any combination thereof (e.g., x and y, but not z).

It is to be understood that the present disclosure is not limited to particular devices or methods, which may, of course, vary. It is also to be understood that the terminology used herein is for the purpose of describing particular embodiments only and is not intended to be limiting. As used herein, the singular forms “a,” “an,” and “the” include singular and plural referents unless the context clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “memory device configured to store data” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Should Applicant wish to invoke Section 112(f) during prosecution, it will recite claim elements using the “means for” [performing a function] construct.

In this disclosure, various “modules” operable to perform designated functions are shown in the figures and described in detail above (e.g., data validation module 852, data management module 854, etc.). As used herein, the term “module” refers to circuitry configured to perform specified operations or to physical, non-transitory computer-readable media that stores information (e.g., program instructions) that instructs other circuitry (e.g., a processor) to perform specified operations. Such circuitry may be implemented in multiple ways, including as a hardwired circuit or as a memory having program instructions stored therein that are executable by one or more processors to perform the operations. The hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority hereto) to any such combination of features. In particular, with reference to the appended claims, features from dependent claims may be combined with those of the independent claims and features from respective independent claims may be combined in any appropriate manner and not merely in the specific combinations enumerated in the appended claims

Although example diagrams to implement the elements of the disclosed subject matter have been provided, one skilled in the art, using this disclosure, could develop additional hardware, software, methods, or apparatuses to practice the disclosed subject matter and each is intended to be included herein.

Additionally, in many instances multiple embodiments are provided; however, no single embodiment must include all aspects and different embodiments or aspects of embodiments may be combined to create alternative/complimentary embodiments. Furthermore, the use of the word alternative in combination with embodiment is not intended to be exclusive and could also be a complimentary embodiment.

In addition to the above described embodiments, those skilled in the art will appreciate that this disclosure has application in a variety of arts and situations and this disclosure is intended to include the same.

1. A method, comprising:
retrieving, by a computer system, location-specific resource data from a resource server that aggregates the location-specific resource data from a plurality of reporting resources, wherein the location-specific resource data indicates a status of one or more resources in a geographic area, and wherein the location-specific resource data indicates a location and availability status of a first mobile emergency services provider;
providing, by the computer system, a map-centric interface that is operable to display the status of the one or more resources in the geographic area, wherein the map-centric interface includes a graphical map that depicts icons for the one or more resources at respective locations on the graphical map, wherein the graphical map depicts a first icon that corresponds to the first mobile emergency services provider and that is selectable to present a user interface element indicating the availability status of the first mobile emergency services provider;
receiving, by the computer system via the map-centric interface, a selection of a particular geographic area, within the geographic area, for which to send a location-specific message;
based on the selection, identifying, by the computer system, a plurality of mobile devices that are currently located in the particular geographic area;
receiving, by the computer system, an indication of the location-specific message to provide to the plurality of mobile devices; and
sending, by the computer system, the location-specific message to the plurality of mobile devices that are currently located in the particular geographic area.

2. The method of claim 1, wherein the location-specific message includes a text-based notification corresponding to the status of at least one of the one or more resources in the particular geographic area.

3. The method of claim 1, wherein the location-specific message includes message data usable by the plurality of mobile devices to populate an interactive map with information indicative of the status of at least one of the one or more resources in the particular geographic area.

4. The method of claim 3, wherein the message data included in the location-specific message is further usable by the plurality of mobile devices to indicate, via the interactive map, a current capacity of the at least one of the one or more resources in the particular geographic area.

5. The method of claim 3, wherein the message data included in the location-specific message is further usable by the plurality of mobile devices to populate the interactive map with additional information indicative of the location, within the particular geographic area, of the first mobile emergency services provider.

6. The method of claim 3, further comprising:
causing content corresponding to the location-specific message to be displayed on one or more digital signs positioned on roadways located within the particular geographic area.

7. The method of claim 6, wherein the content includes a second graphical map that corresponds to the particular geographic area, wherein the second graphical map depicts icons indicative of a location and status of at least one resource within the particular geographic area.

8. (canceled)

9. A non-transitory, computer-readable medium having instructions stored thereon that are executable by a computer system to perform operations comprising:
retrieving location-specific resource data from a resource server that aggregates the location-specific resource data from a plurality of reporting resources, wherein the location-specific resource data indicates a status of one or more resources in a geographic area, and wherein the location-specific resource data indicates a location and availability status of a first mobile emergency services provider;
providing a map-centric interface that is operable to display the status of the one or more resources in the geographic area, wherein the map-centric interface includes a graphical map that depicts icons for the one or more resources at respective locations on the graphical map, wherein the graphical map depicts a first icon that corresponds to the first mobile emergency services provider and that is selectable to present a user interface element indicating the availability status of the first mobile emergency services provider;
receiving, via the map-centric interface, a selection of a particular geographic area, within the geographic area, for which to send a location-specific message;
based on the selection, identifying a plurality of mobile devices that are currently located in the particular geographic area;
receiving an indication of the location-specific message to provide to the plurality of mobile devices; and
sending the location-specific message to the plurality of mobile devices that are currently located in the particular geographic area.

10. The non-transitory, computer-readable medium of claim 9, wherein the operations further comprise:
periodically retrieving location information from a set of mobile devices associated with an emergency notification service; and
wherein the identifying the plurality of mobile devices includes selecting the plurality of mobile devices from the set of mobile devices based on the location information.

11. The non-transitory, computer-readable medium of claim 9, wherein the operations further comprise:
periodically receiving location information from a set of mobile devices associated with an emergency notification service; and
wherein the identifying the plurality of mobile devices includes selecting the plurality of mobile devices from the set of mobile devices based on the location information.

12. The non-transitory, computer-readable medium of claim 9, wherein the identifying the plurality of mobile devices that are currently located in the particular geographic area includes:
in response to receiving the selection of the particular geographic area via the map-centric interface, sending a request, to the plurality of mobile devices, for location information associated with each of the plurality of mobile devices.

13. The non-transitory, computer-readable medium of claim 9, wherein the operations further comprise:
receiving, from a first mobile device, second location-specific resource data that indicates an updated status of at least one resource in the geographic area; and
updating the map-centric interface to display the updated status of the at least one resource on the graphical map.

14. The non-transitory, computer-readable medium of claim 9, wherein the location-specific message includes message data usable by the plurality of mobile devices to populate an interactive map with information indicative of the status of at least one of the one or more resources in the particular geographic area.

15-20. (canceled)

21. A system, comprising:
at least one processor;
a non-transitory, computer-readable medium having instructions stored thereon that are executable by the at least one processor to cause the system to:
retrieve location-specific resource data from a resource server that aggregates the location-specific resource data from a plurality of reporting resources, wherein the location-specific resource data indicates a status of one or more resources in a geographic area, and wherein the location-specific resource data indicates a location and availability status of a first mobile emergency services provider;
provide a map-centric interface that is operable to display the status of the one or more resources in the geographic area, wherein the map-centric interface includes a graphical map that depicts icons for the one or more resources at respective locations on the graphical map, wherein the graphical map depicts a first icon that corresponds to the first mobile emergency services provider and that is selectable to present a user interface element indicating the availability status of the first mobile emergency services provider;
receive, via the map-centric interface, a selection of a particular geographic area, within the geographic area, for which to send a location-specific message;
based on the selection, identify a plurality of mobile devices that are currently located in the particular geographic area;
receive an indication of the location-specific message to provide to the plurality of mobile devices; and
send the location-specific message to the plurality of mobile devices that are currently located in the particular geographic area.

22. The system of claim 21, wherein the location-specific message includes message data usable by the plurality of mobile devices to populate an interactive map with information indicative of the status of at least one of the one or more resources in the particular geographic area.

23. The system of claim 22, wherein the message data included in the location-specific message is further usable by the plurality of mobile devices to populate the interactive map with additional information indicative of the location, within the particular geographic area, of the first mobile emergency services provider.

24. The system of claim 22, wherein the instructions are further executable to cause the system to cause content corresponding to the location-specific message to be displayed on one or more digital signs positioned on roadways located within the particular geographic area.

25. The system of claim 24, wherein the content includes a second graphical map that corresponds to the particular geographic area, wherein the second graphical map depicts icons indicative of a location and status of at least one resource within the particular geographic area.

26. The method of claim 1, further comprising:
receiving, by the computer system, a second indication of a second location-specific message for the first mobile emergency services provider; and
sending, by the computer system, the second location-specific message to a particular mobile device associated with the first mobile emergency services provider.
